(19) United States
(12) Patent Application Publication
(10) Pub. No.: US 2010/0235882 A1
(43) Pub. Date: Sep. 16, 2010

(54) METHOD AND SYSTEM FOR USING TOKENS IN A TRANSACTION HANDLING SYSTEM

(75) Inventor: Daryl Richard Moore, Astoria, OR (US)

Correspondence Address: Law Offices of Toussaint L. Myricks, PLLC, P.O. Box 1358, Renton, WA, 98057, US

(73) Assignee: GIDAH, INC., Astoria, OR (US)

(21) Appl. No.: 12/404,225

(22) Filed: Mar. 13, 2009

(51) Int. Cl. G06Q 20/00; G06F 21/00; G06F 15/16

(52) U.S. Cl. 726/3; 709/219; 705/39; 709/206

(57) ABSTRACT

A method and system for using tokens in a transaction handling system comprising receiving at least one token transmitted from a sending device, the at least one token having a user-defined value and a plurality of data fields, locking the at least one transmitted token from a receiving device and redeeming from the receiving device the user-defined value of the locked at least one transmitted token.

### FIELD

The present disclosure relates generally to information management, and in particular but not exclusively, relates to a method and systems for generating and using tokens for voluntary redemption in a transaction handling system.

### BACKGROUND

The rapid growth of the Internet as both an instrument for communication and commerce has been dramatic in the past few decades. Indeed, no other medium except perhaps for the telephone has experienced such dramatic and widespread growth in its adoption from the earliest stages. The rapid growth in importance of the Internet and its various means for facilitating communication has ensured that it is essential tool for fostering communication and commerce around the world. However, a number of significant technical, commercial and sociological problems have arisen along with the rapid rate of growth in the usage of Internet communication and commerce services.

Specifically, there has been dramatic growth in the amount and variety of electronic mail communications which offer little to no value to its recipients. Such communications have come to be known as electronic “spam” because of its rapid proliferation and, more often than not, valueless content. Clearly, Internet offers significant communication benefits and advantages. For the present time, however, there is no effective way to insure that information exchanged between parties has value.

Certain Internet services have attempted to address this problem of “spam” by restricting access to certain types of websites. Specifically, Internet forums and bulletin boards have been created for communities of online users with common interests. The goal in creating such communities was to limit content contributions only to those of most interest to the members of these communities. In practice, many of these communities often become no more than highly condensed locations for the posting of information having little to no real value to members of the community. Controlling the quality of the content posted in such forums and communities is a major problem with few effective solutions.

Moreover, the widespread adoption and use of electronic mail services as well as the rapid rate of growth in the trade of subscriber lists has resulted in an exponential growth in the amount of “spam” communications. A common complaint in the present era is that if one voluntarily provides their email address to one service provider, very often unwanted email messages may be received from third parties with whom the initial subscriber had no previous contact. The use of “white listing” and “black listing” of email address in certain email services is one interim solution. However, this solution comes with the added procedural burden of identifying the specific email addresses which are to be “black listed” or “white listed.” For sure, the uncontrolled redistribution and profiting from the sales of subscriber lists to unknown third parties is a major business, but a business which nonetheless has produced consequences which have become a nuisance for email users and is increasingly creating consumers who are increasingly less trustful of the abilities of companies to handle and maintain their e-mail addresses in confidence.

Thus, a tremendous need exists for a system and methods that can significantly reduce the proliferation of “spam” while also insuring that the information received is not valueless from the recipient's perspective.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 illustrates a block diagram of an information system including multiple sending and receiving devices interacting with a token management system in an embodiment.

FIG. 2 illustrates a block diagram of a server executing a token management system in an embodiment.

FIG. 3A illustrates a block diagram of interfaces for a token management system in an embodiment.

FIG. 3B illustrates a block diagram of a token management system in an embodiment.

FIG. 4A illustrates a token data table for a token management system in an embodiment.

FIG. 4B illustrates a user profile table for a token management system in an embodiment.

FIG. 5A illustrates a token structure for a token management system in an embodiment.

FIG. 5B illustrates a token used for a token management system in an embodiment.

FIG. 5C illustrates a token included in a token group for a token management system in an embodiment.

FIG. 6 illustrates a flowchart of a process for user registration in a token management system in an embodiment.

FIG. 7A illustrates a flowchart of a process for verification of a user alias in a token management system in an embodiment.

FIG. 7B illustrates a flowchart of a process for generating and using tokens in a token management system in an embodiment.

FIG. 8A illustrates a flowchart of a process for generating a token in a token management system in an embodiment.

FIG. 8B illustrates a flowchart of a process for generating a token in a token management system in an embodiment.

FIG. 8C illustrates a flowchart of a process for creating a token group in a token management system in an embodiment.

FIG. 9 illustrates a flowchart of a process for authenticating a token in a token management system in an embodiment.

FIG. 10 illustrates a diagram of a system and method for acquiring a token in a token management system in an embodiment.

FIG. 11 illustrates a diagram of a system and method for acquiring a token group in a token management system in an embodiment.

FIG. 12 illustrates a diagram of a system and method for authenticating a token in a token management system in an embodiment.

FIG. 13 illustrates a diagram of a system and method for locking a token in a token management system in an embodiment.

FIG. 14 illustrates a diagram of a system and method for redeeming a token in a token management system in an embodiment.

FIG. 15 illustrates a diagram of a system and method for acquiring a token in a token management system in an embodiment.

FIG. 16 illustrates a diagram of a system and method for acquiring a token group in a token management system in an embodiment.

FIG. 17 illustrates a diagram of a system and method for authenticating a token in a token management system in an embodiment.

FIG. 18 illustrates a diagram of a system and method for locking a token in a token management system in an embodiment.

FIG. 19 illustrates a diagram of a system and method for redeeming a token in a token management system in an embodiment.

FIG. 20 illustrates a diagram of a system and method for insuring the delivery of valuable information between sending and receiving devices using a token management system in an embodiment.

FIG. 21 illustrates a diagram of a system and method for payment of a resource, product or service using a token management system in an embodiment.

FIG. 22 illustrates a diagram of a system and method for performing an auction using a token management system in an embodiment.

FIG. 23 illustrates a diagram of a system and method for verifying intent to enter into a transaction using a token management system in an embodiment.

FIG. 24 illustrates a diagram of a system and method for reducing electronic mail “spam” using a token management system in an embodiment.

FIG. 25 illustrates a diagram of a system and method for reducing electronic mail “spam” using a token management system in an embodiment.

FIG. 26 illustrates a diagram of a system and method for reducing “spam” in an online forum using a token management system in an embodiment.

FIG. 27 illustrates a diagram of a system and method for token creation and redemption without token locking using a token management system in an embodiment.

FIG. 28 illustrates a diagram of a system and method for token creation and redemption with token locking using a token management system in an embodiment.

FIG. 29 illustrates a diagram of a system and method for token management after token lock expiration using a token management system in an embodiment.

FIG. 30 illustrates a diagram of a user interface for creating a token in a token management system in an embodiment.

FIG. 31 illustrates a diagram of a user interface for receiving a token in a token management system in an embodiment.

FIG. 32 illustrates a diagram of a user interface for generating a list of tokens in a token management system in an embodiment.

FIG. 33 illustrates a diagram of a user interface for describing a token group in a token management system in an embodiment.

### DETAILED DESCRIPTION

In the description to follow, various aspects of embodiments will be described, and specific configurations will be set forth. These embodiments, however, may be practiced with only some or all aspects, and/or without some or these specific details. In other instances, well-known features are omitted or simplified in order not to obscure important aspects of the embodiments.

Various operations will be described as multiple discrete steps in turn, in a manner that is most helpful in understanding each disclosed embodiment; however, the order of description should not be construed as to imply that these operations are necessarily order dependent. In particular, these operations need not be performed in the order of presentation.

The description repeatedly uses the phrases “in one embodiment”, which ordinarily does not refer to the same embodiment, although it may. The terms “comprising”, “including”, “having”, and the like, as used in the present disclosure are synonymous.

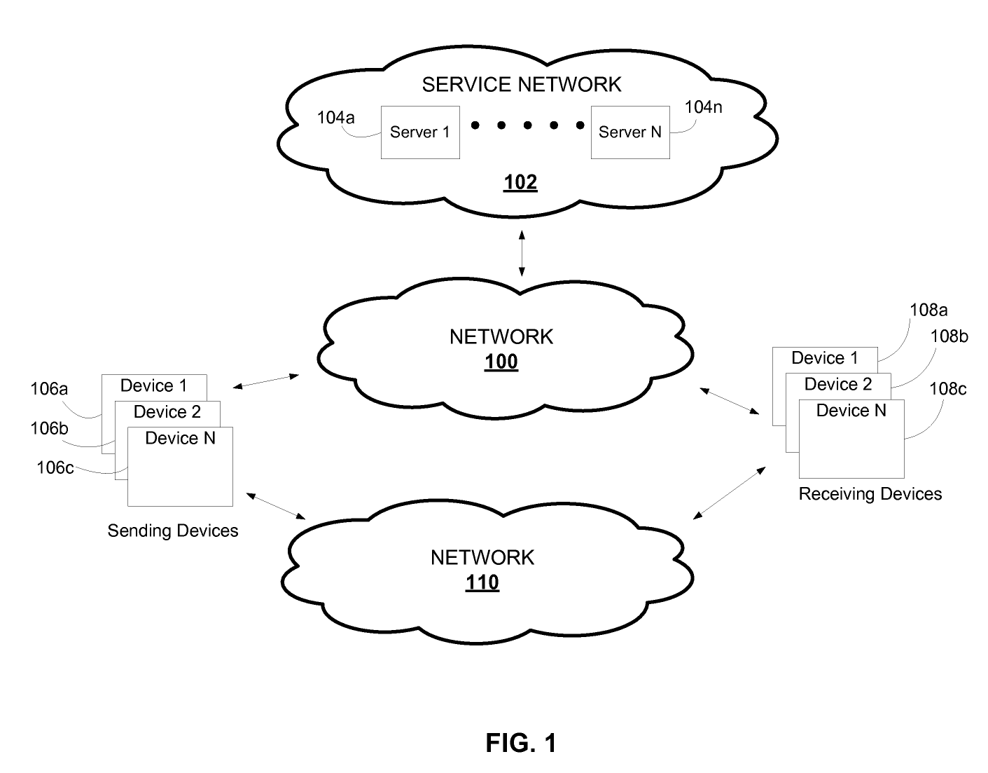

FIG. 1 is a block diagram of an exemplary embodiment of an information system. The information system includes a computer communications network 100, sending devices 106a, 106b, 106c and multiple receiving devices 108a, 108b, 108c. In the depicted embodiment, each of the sending devices 106a, 106b, 106c and the receiving devices 108a, 108b, 108c are coupled to a first communications network 100 and a second communications network 110 for the transmission and receipt of messages and transaction tokens between these devices. In an alternative embodiment, the sending devices 106a, 106b, 106c and the receiving devices 108a, 108b 108c are coupled to multiple communications networks. The information system also includes a token management system executing on a service network 102. The token management system is comprised of one or more computer servers 104a, 104n and is coupled to the communications network 100 to enable the sending devices 106a, 106b, 106c to acquire and send one or more tokens to one or more receiving devices 108a, 108b, 108c. The receiving devices 108a, 108b, 108c include a variety of computer and communication devices, including desktop computers, laptop computers, personal digital assistants, cellular telephones, Internet-enabled telephones, and other types of conventional communication devices which can be controlled by end users for the creation and transmission of messages or other forms of informational content. The receiving devices 108a, 108b, 108c are comprised of personal digital assistants, desktop computers, laptop computers, Internet-enabled telephones, and cellular telephones that can receive messages sent from one or more of the sending devices 106a, 106b, 106c over the communications networks 100, 110.

The token management system executing on the service network 102 is used by one or more of the sending devices 106a, 106b, 106c to create and manage the use of one or more transaction tokens. The transaction tokens are acquired by one or more of the sending devices 106a, 106b, 106c on the first communications network 100 for transmission either independently or as attachments to electronic message communications over the second computer communications network 110 to one or more receiving devices 108a, 108b, 108c. The service network 102 is comprised of one or more server computers, each of which includes one or more software components for execution of the token management system. As used herein, the term “token management system” is a transaction handling system that is capable of creating and managing the distribution and use of tokens which can be voluntarily redeemed by end users of the one or more receiving devices 108a, 108b, 108c.

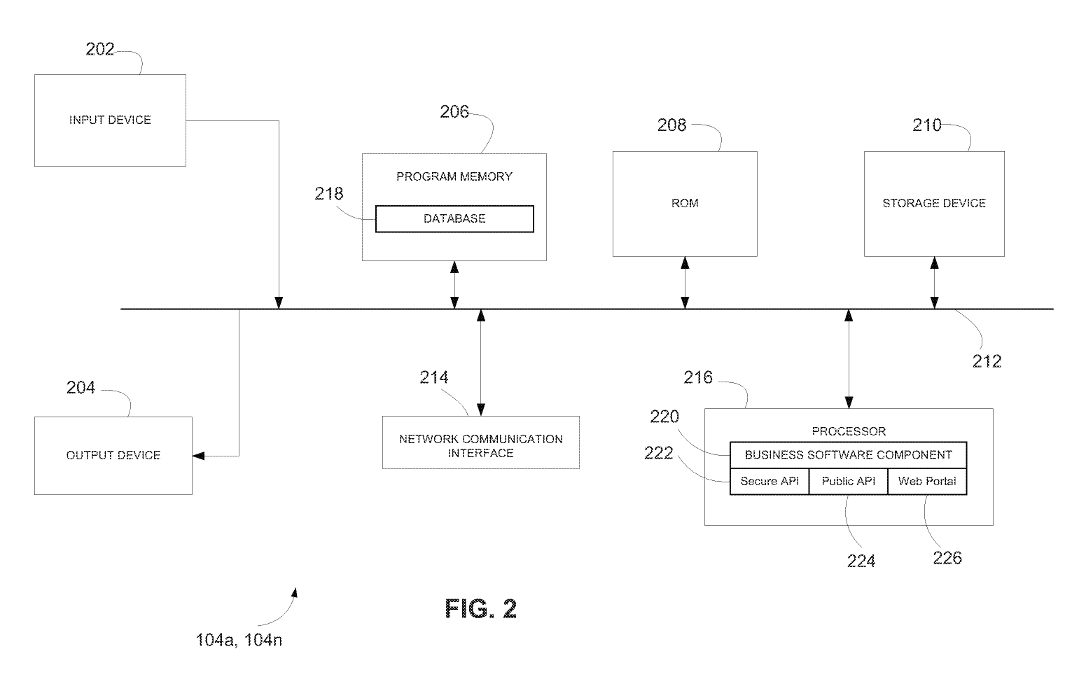

FIG. 2 is a block diagram of an embodiment of a server computer 104a, 104n. Each server computer 104a, 104n includes one or more input devices 202, one or more output devices 204, a program memory 206, a read-only memory 208, a secondary storage device 210, a network communication interface 214 and a central processor 216. A data communication bus 212 is included onto which each of the components included in the server computer 104 are coupled for inter-component communication and data transfers. Software components implementing the token management system and executed by a server computer 104a, 104n are also illustrated in this FIG. 2. As shown, a database 218 resides in the program memory 206 and is coupled to the processor 216 over the data communication bus 212 to receive and reply to data storage and retrieval requests from the business software component 220. In addition to data management with the database 218, the business software component 220 also manages external interactions including user inputs and the display of results from user requests on one or more interfaces. A secure application programming interface (API) 222, a public API 224 and a web portal interface 226 are provided in an embodiment. The business software component 220 interacts with each of the application programming interfaces and the web interface portal to receive, execute and generate results from requests received from end users using one or more of the application programming interfaces 222, 224, 226. Network communication interface 214 is used for computer communications between the server computers 104a, 104n in an embodiment of a token management system including multiple computer servers.

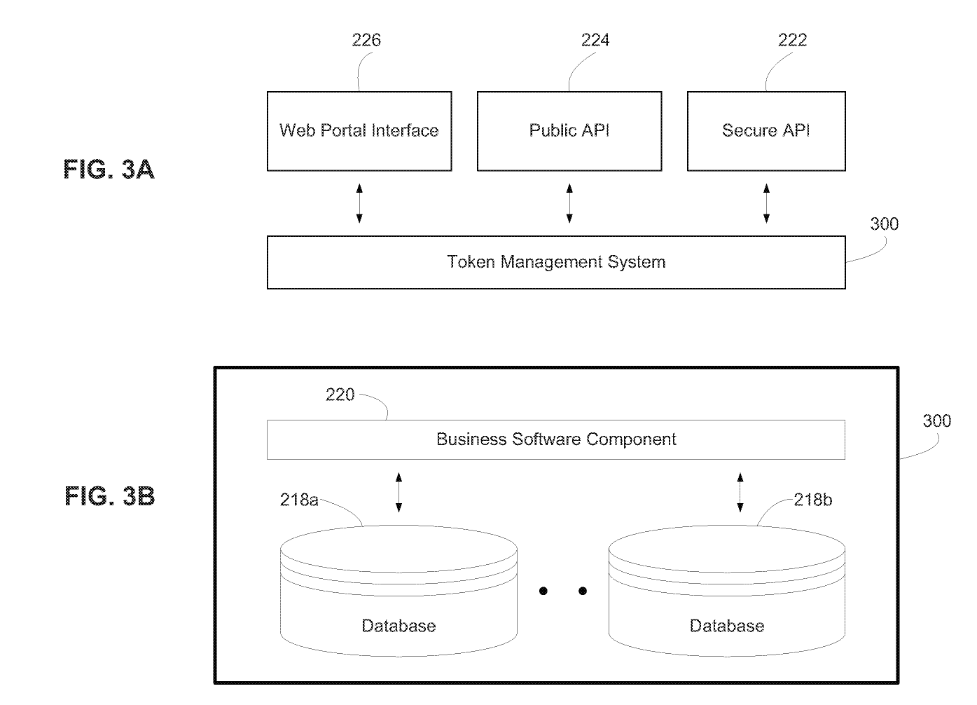

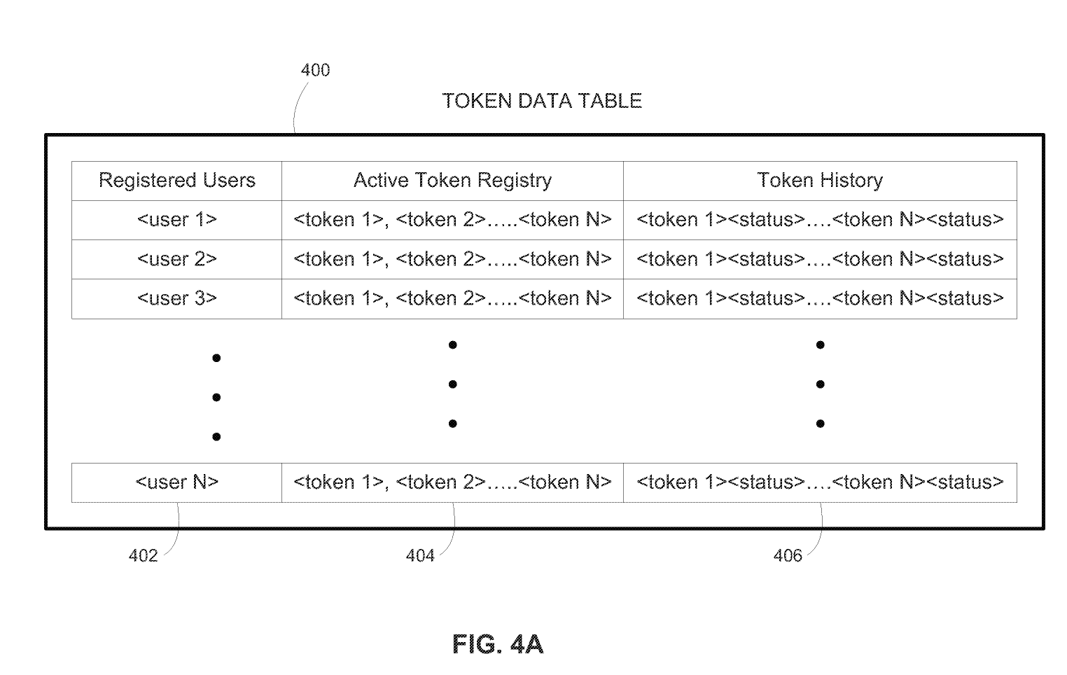

FIGS. 3A and 3B illustrate several software components implementing a token management system on the service network 102. FIG. 3A shows web interface portal 226 communicatively coupled to the token management system 300. This figure also depicts public application programming interface (“Public API”) 224 and secure application programming interface (“Secure API”) 222 as being communicatively coupled to the token management system 300. FIG. 3B is an illustration of the components of the token management system 300 implemented on the service network 102. The token management system 300 is comprised of a business software component 220 and one or more databases 218, 218b. In an embodiment, the web portal interface 226 is used to receive, authenticate and reply to requests from end users to create, acquire, authenticate, lock and redeem transaction tokens over publicly accessible hypertext transfer protocol (“HTTP”) communication connections. Notwithstanding the ability of end users to interact with the token management system 300 over HTTP connections, only authenticated users can lock and redeem the user-defined values associated with transaction tokens. The Public API 304 enables programmatic communication to be established between end users who execute independent software applications having an embedded API key that is recognized by the Public API 224. Communications between these applications and the Public API 224 occur over conventional HTTP connections or other non-secure communication connections. Once recognized and authenticated, programmatic users can use the Public API 224 to login to the token management system 300 and create, acquire and authenticate transaction tokens. Likewise, the Secure API 222 enables programmatic communication to be established between end users who execute software applications having an embedded API key that is recognized by the Secure API. Communications between these applications and the Secure API, however, occur over secure or encrypted communication connections for enhanced information security. Once recognized and authenticated, programmatic users can use the Secure API 222 to login to the token management system 300 and create, acquire, authenticate, lock and redeem the user-defined value associated with transaction tokens.

The business software component 220 in the token management system 300 implements the business rules which translate end user requests received from the user interfaces into executed operations on data stored in the one or more databases 218a, 218b. More specifically, the business software component 220 executes requests to create new tokens, to track their status (e.g., Open, Locked, Redeemed, Expired, etc.) and to manage financial accounts representing stored user-defined values associated with each transaction token. Thus, the business software component 220 maintains user accounts for registered users which include the user-defined values for their transaction tokens as well as system-maintained interim accounts into which transaction values are transferred at the time transaction tokens are locked. Additionally, the business software component 220 ensures timely transfers of token values to the accounts of registered users upon receipt of token redemption requests.

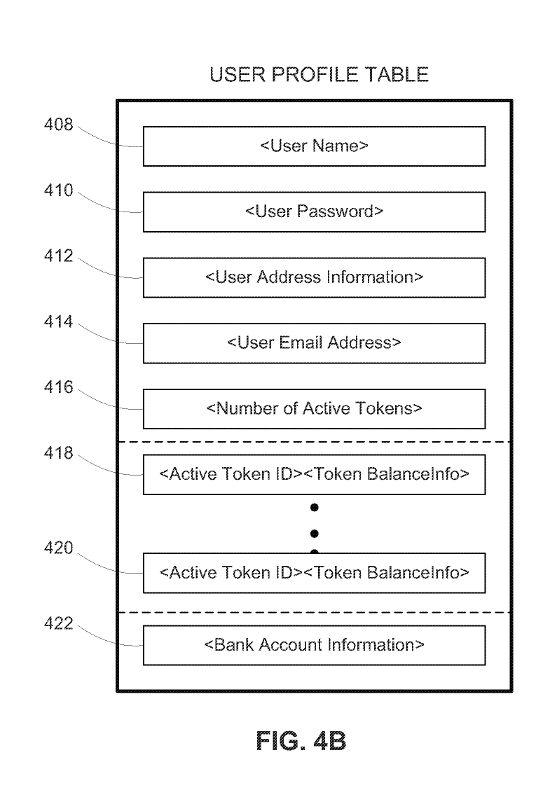

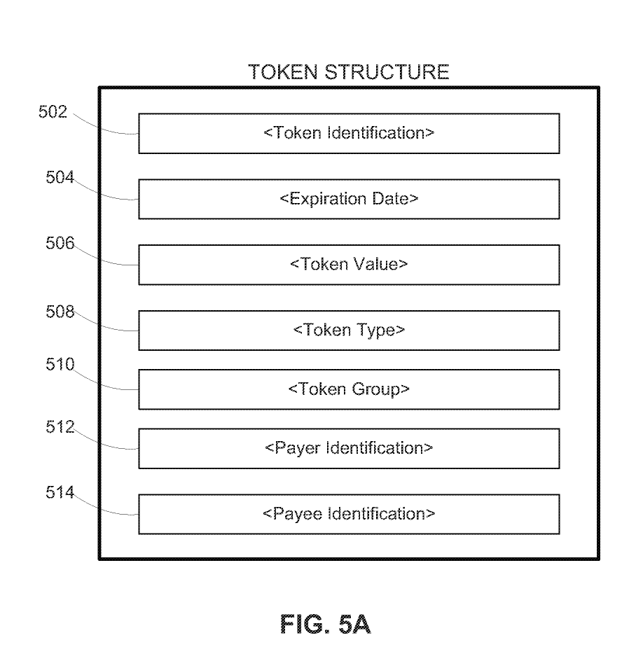

FIG. 4A illustrates an embodiment of a token database table which is stored in one or more of the databases 218, 218 and is comprised of a listing of registered users 402, a token registry 404 and a token history 406. The list of registered users 402 includes a list of users of sending devices 106a, 106b, 106c and the users of one or more receiving devices 108a, 108b, 108c having accounts in the token management system 300 which includes a registered a user profile and one or more token data tables 400. The token registry 404 includes a list of tokens which have been created and which are associated with a registered user. The token history field 406 for each registered user stores the current status of each token associated with each registered user. For example, <user 1>, as shown in FIG. 4A, has tokens in the token registry. The token history field 406 stores the current status of each token associated with <user 1>, which status may be “active,” “expired,” “locked,” or “redeemed.”

FIG. 4B is an illustration of a user profile table in an embodiment. The user profile table is stored in the database 218a, 218b and includes multiple fields. Among the data fields included in the user profile table are a user name field 408, a user password field 410, a user address information field 412, a user e-mail address field 414, a number of active tokens field 416, a listing of active token identifications (“Active Token IDs”) 418-420 with each Active Token ID having an associated user-defined value or balance. The last field included in the user profile table is a bank account information field 422 which includes information such as a bank account number and a routing number in an embodiment. In an alternative embodiment, the bank account information 422 also includes one or more credit card numbers and debit card numbers for a registered user.

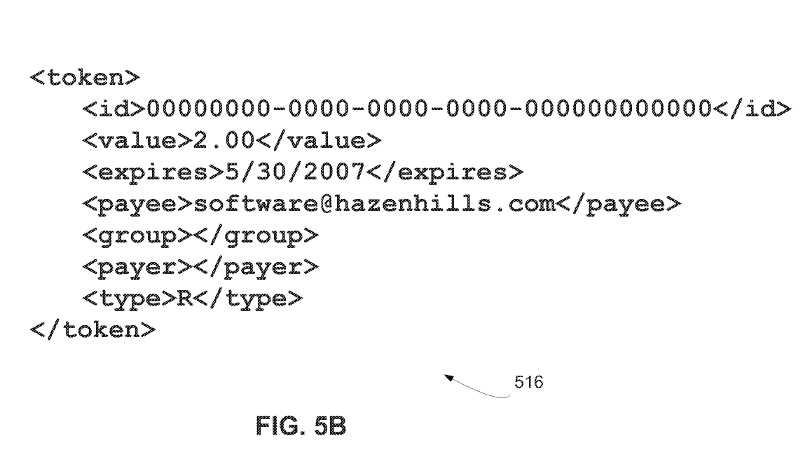

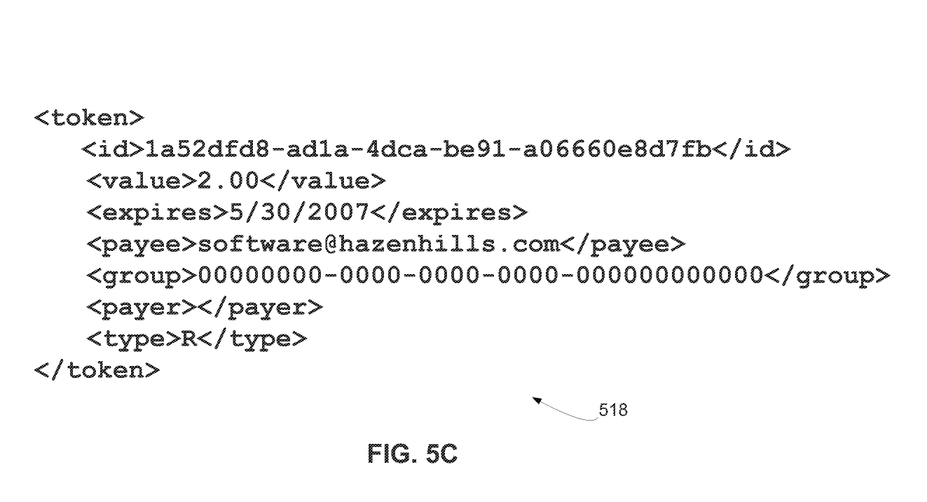

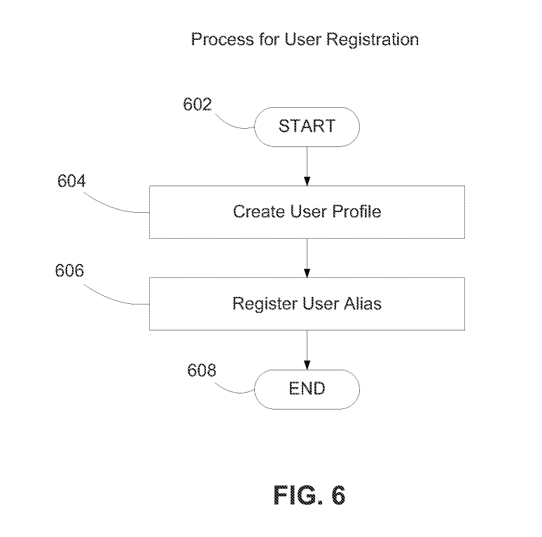

FIG. 5A is an illustration of the structure of a transaction token in an embodiment. Each token used in the token management system 300 includes a token identification field 502, an expiration date field 504, a token value field 506, a token type field 508, a token group field 510, a payer identification field 512, and a payee identification field 514. The contents of the token group field 510, payer identification field 512 and payee identification 514 are optional and include data for specific applications of the token management system 300 and the tokens created in the system.

FIG. 5B illustrates a token 516 used in the token management system 300 in an embodiment. Token 516 includes a token identification which is 00000000-0000-0000-0000-000000000000, a token value of $2.00, a token expiration date of May 30, 2007, a token payee e-mail address of “software@hazenhills.com” and a token type entry of “R” which represents a “Raked” token type. FIG. 5C illustrates an alternative embodiment of a token 518 having a token identification of 1a52dfd8-ad1a-4dca-be91-a06660e8d7fb, a token value of $2.00, a token expiration date of May 30, 2007, a token payee e-mail address of “software@hazenhills.com” and a token group identification code of 00000000-0000-0000-0000-000000000000 and again a token type field entry of “R” for a raked token type.

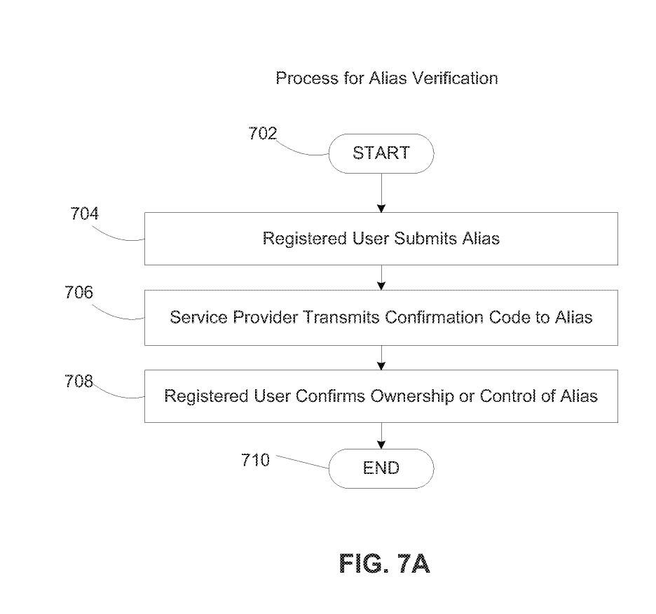

FIG. 6 illustrates a process for user registration in the token management system 300 in an embodiment. The process commences at step 602 and requires the creation of a user profile, at step 604, and the registration of a user alias, at step 606, with the process completing as shown at step 608 once both the user profile information and the registered user alias are stored in the token management system 300. The contents of the user profile table which are stored in the token management system 300 are as shown in FIG. 4B.

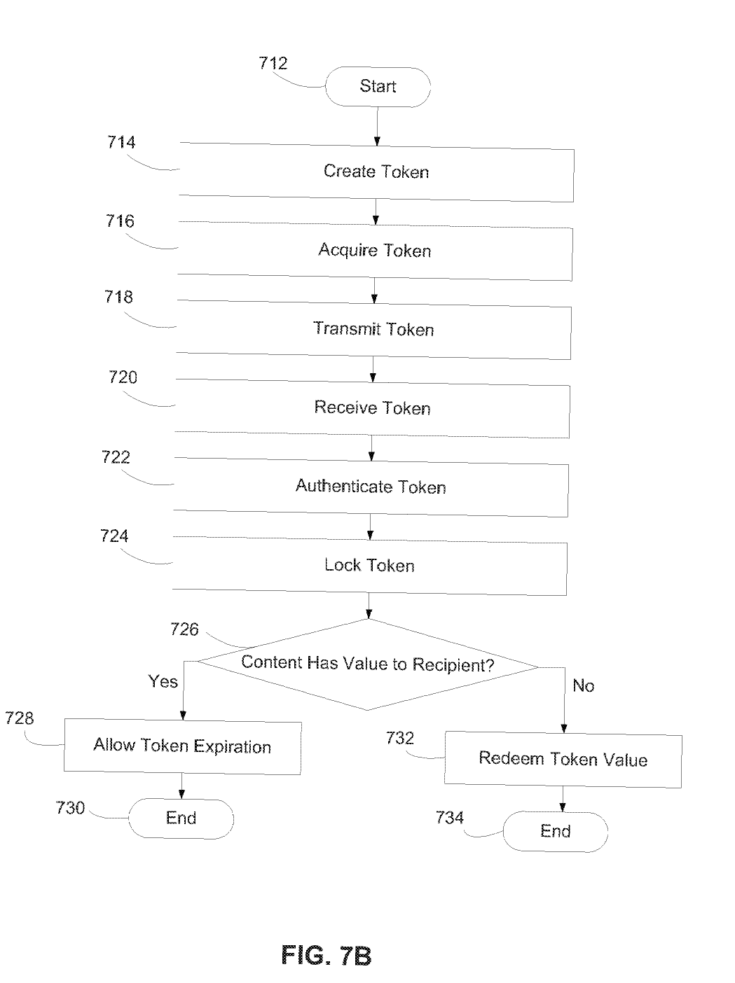

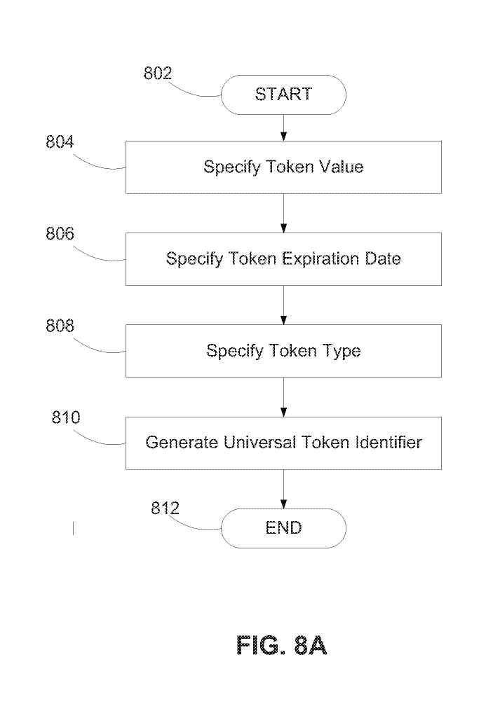

FIG. 7A illustrates the process for verifying a registered user alias in the token management system 300 in an embodiment. The process commences at step 702 and begins with having a registered user submit an alias, at step 704, and the service provider operating the token management system 300 transmitting a confirmation code to the registered user alias, as shown at step 706. An user alias in an embodiment is the electronic mail address of a registered user. In alternative embodiments, other unique identifiers can be used to establish one or more user aliases in the token management system 300. Once entered, the registered user confirms ownership or control of the alias, at step 708, after receipt of a confirmation code transmitted from the service provider. The verification process ends as shown at step 710 upon confirmation of the ownership or control of the alias by the registered user.

FIG. 7B illustrates a process for using the token management system 300 in an embodiment. This process commences at step 712 with the creation of a new token, as shown at step 714, followed by the acquisition of the token over the first communications network 100 by a sending device 106a, 106b, 106c, as shown at step 716. After receipt of a token, a sending device 106a, 106b, 106c can transmit a token over the second communications network 110, as shown at step 718, to one or more receiving devices 108a, 108b, 108c. In an embodiment, the second communications network 110 is a wireless communication network supporting protocols such as WI-FI (or Wireless Local Area Network), WiMAX (Worldwide Interoperability for Microwave Access), GSM (Global System for Mobile) or W-CDMA (Wideband-Code Division Multiple Access). In one embodiment, a token is transmitted as a clear-text attachment to an electronic mail message over the computer communications network 110 to one or more receiving devices 108a, 108b, 108c. In an alternative embodiment, the token is transmitted over a secure communication connection to a receiving device 108a, 108b, 108c. The secure communication connection employs a cryptographic protocol such the Secure Sockets Layer protocol. In another alternative embodiment, the token can be transmitted using encrypted text over either communications network 100, 110 to one and more receiving devices 108a, 108b, 108c. In each of the aforementioned embodiments, the communication between a token management system 300, the sending devices 106a, 106b, 106c, and the receiving devices 108a, 108b, 108c occurs over the first and second communications networks 100, 110 even though various forms of clear-text techniques, encrypted text techniques and cryptographic protocols are employed for inter-device communication.

As illustrated in this embodiment, one or more receiving devices 108a, 108b, 108c can receive the transmitted token over the second communications network 110, as shown as step 720, and once received, the user of the receiving device 108a, 108b, 108c can proceed to authenticate the token, as shown at step 722. Authentication is performed over the first communications network 100. The authentication of a received token involves the uploading of the token to the token management system 300 using a web portal interface 226 or, if performed programmatically, using an application programming interface 222, 224. In one embodiment, during the authentication process, the token management system 300 evaluates the content of each data field in the token to determine if the data is identical to data stored in the token database 218. In an alternative embodiment, the authentication process can be accomplished from a comparison of data in less than all of the data fields of a token. In the token management system 300, tokens are created and reside only in the token management system 300 and replicated copies of each token are available for downloading and acquisition onto sending devices 106a, 106b, 106c and subsequent transmission to one or more receiving devices 108a, 108b, 108c.

Once a token is received, the user of a receiving device 108a, 108b, 108c uploads the replicated copy of the received token to the token management system 300. In this way, a matching comparison can be performed quickly to confirm that all data in each of the data fields of a replicated token are equivalent to all of the data associated with the token created in the token management system 300. Once authenticated, the end user of a receiving device 108 can proceed to lock a token, as shown at step 724. The locking of a token prevents any third party from locking the same token and therefore preserves the authenticity of the token received by the end user of a receiving device 108a, 108b, 108c. The locking of a token is accomplished from a comparison of the token payee field in a token to one or more aliases for the payee stored in the token database 218 in the token management system 300. If a matching comparison is performed successfully (i.e., a match to at least one stored alias occurs), then the token will be locked and the user-defined value associated with the token will be transferred to an interim holding in the token management system 300. The account balance of the token will be debited from the account balance of the token creator and placed into this interim holding account.

Once a token is locked, an end user of a receiving device 108a, 108b, 108c can evaluate the contents associated with the token. For example, if a token was transmitted as a clear-text attachment to an electronic mail message, the end user can review the content of the message to determine if it has subjective value or satisfies some end user defined criterion. If it is deemed to have some subjective value or satisfies a criterion, then the end user can allow the time for redemption of the token value to expire, as shown at step 728, after which the token transmission process concludes, as shown at step 730.

However, if the end user of the receiving device 108a, 108b, 108c concludes that the content of the message has little to no value, then the end user can elect to redeem the token value, as shown at step 732. The token evaluation process concludes, as shown at step 734. In redeeming the token value, the token management system 300 will transfer the user-defined value, or some other user-specified sum less than the user-defined value, from the interim holding account to the user account for the receiving end user provided the end user is a registered user in the token management system 300.

The decision process (step 726) applied by an end user in determining whether the content of the message or information provided with the transmitted token has value enables the end user to exercise complete control over the value of access to the end user since token value can be readily redeemed on a voluntary basis. Thus, a recipient can establish an informational value as well as an economic value on the right of a sender to transmit a message to the end user. The measure of this valuable right becomes the user-defined value, or a lesser user-specified value, that can be redeemed within the token management system 300. The lower the value of the content or information transmitted by the sender, the higher the price of access to the recipient (i.e., the recipient has the right to redeem the full user-defined value if the content has little to no value based only on the recipient's subjective criterion). In this way token suppliers will know in advance that there will be voluntary redemption of the token value for the transmission of less than valuable or valueless information, while the recipients of tokens can be compensated for the receipt of information which has little to no value according to their own established criterion for informational content provided with token (e.g., electronic mail messages, auction bids, etc.).

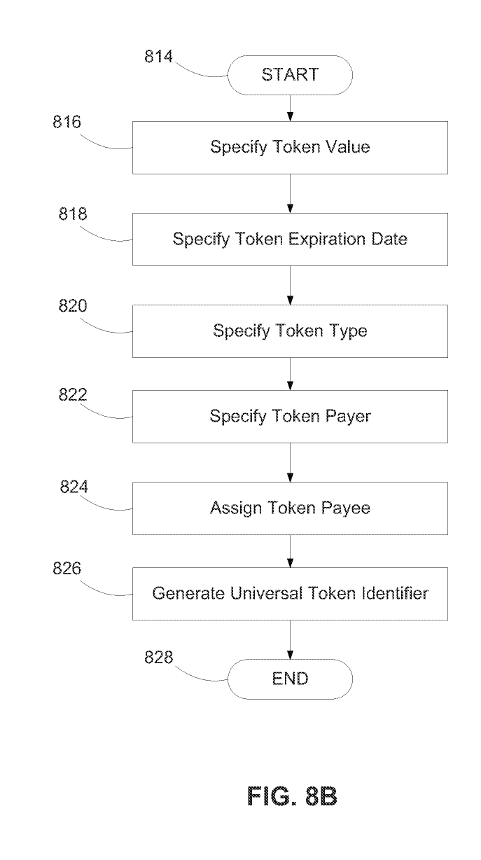

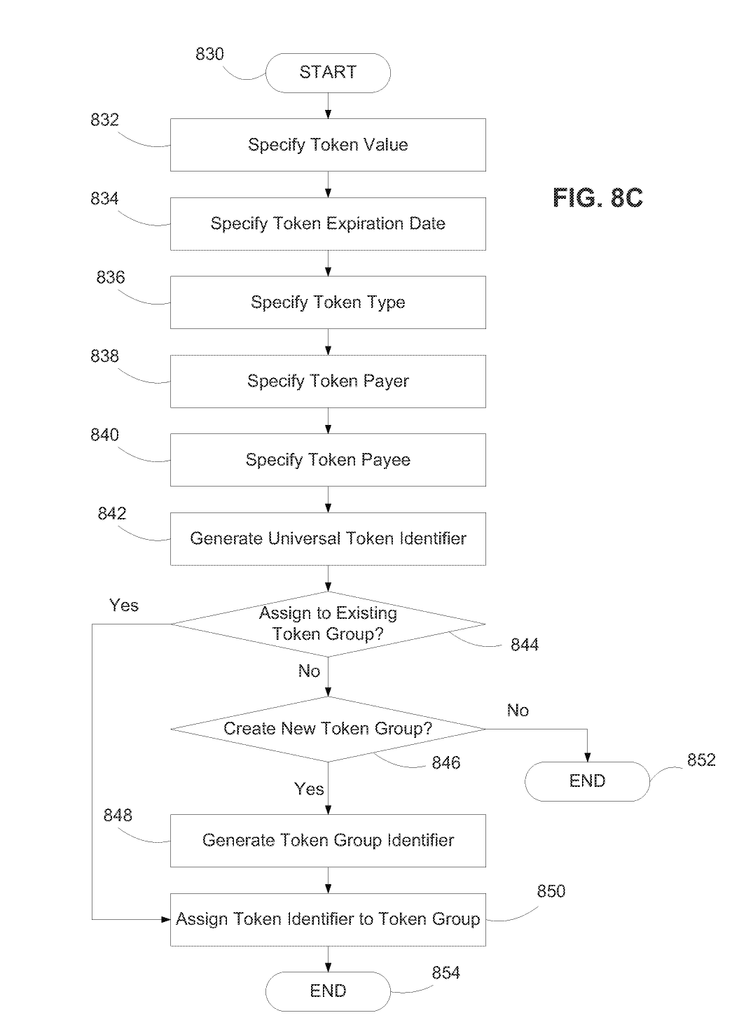

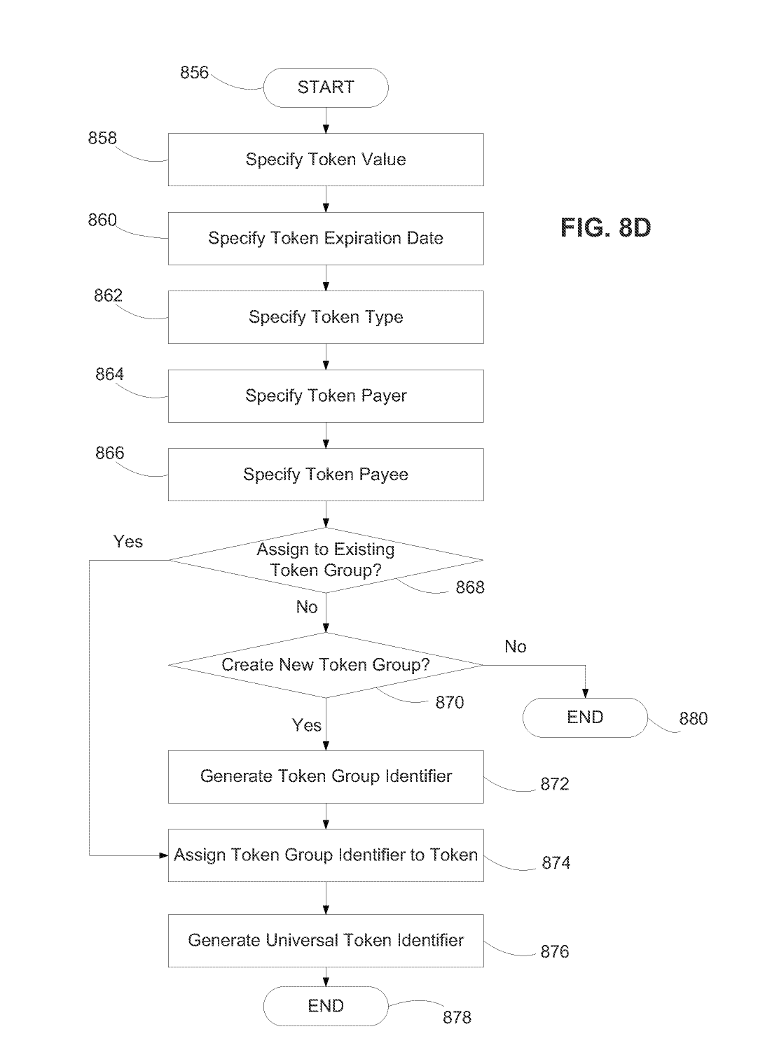

FIG. 8A illustrates a process for creation of a new token in an embodiment. The process commences at step 802 with a registered user specifying a token value (step 804), followed by the user's specification of a token expiration date (step 806), the specification of a token type (step 808) and the generation of a unique token identifier by the token management system 300 at step 810. Upon creation of the unique token identifier, the token creation process completes (step 812). In operation, two different types of tokens are used in the token management system 300. Upon creation of a token called a “regular” type token, a value is associated with that token for redemption within the token management system 300. Specifically, in the event a “regular” type token is redeemed, the token management system 300 will transfer the user-defined value from the user account of the token creator to the user account of the token redeemer on the token management system 300. The actual monetary value of the user-defined value is not withdrawn out of the token management system 300, but is merely transferred between user accounts of registered users.

A second type of token, “a raked” type token, is created for the purpose of allowing the recipient of such tokens to immediately redeem and withdraw the value of the token out of the token management system 300. Although, a “regular” type token has a value which is maintained and actively used within the token management system 300, the value cannot be withdrawn out of the token management system 300 until a recipient expressly requests the withdrawal of the user-defined value for the token. Upon request, a transfer-fee is charged to the user account of the token redeemer and the value can be withdrawn out of the system 300. The transfer-fee is transferred to a token-transaction-redemption account in the token management system 300.

FIG. 8B is an illustration of an alternative embodiment of a process for creating a token. This process commences at step 814 and proceeds with the specifying of a token value at step 816, the specifying of a token expiration date at step 818, the specifying of a token type at step 820, the specifying of a token payer at step 822, the assigning of a token payee identification at step 824 and the generation of a universal token identifier at step 826. Upon generation of the universal token identifier, the process concludes, as shown at step 828. The token management system 300 automatically generates a universal token identifier for each token created and used in the token management system 300. However each registered user must specify the token payer, as shown at step 822, and specify and optionally, enter an alias of a token payee, as shown at step 824.

FIG. 8C is an illustration of a process for generating token groups and assigning multiple tokens to a new token group in an embodiment. The process commences at step 830 and involves the specifying of a token value at step 832, the specifying of a token expiration date at step 834, the specifying of a token type at step 836, specifying a token payer using an alias for identification at Step 838, specifying a token payee using an alias for identification at step 840 and the generation of a universal token identifier for each generated token, as shown at step 842. Afterwards, the token management system 300 confirms with the end user whether the newly created token is to be assigned to an existing token group, as shown at step 844. If so, the generated universal token identifier for the new token is assigned to the token group, as shown at step 850 and the process ends at step 854. However, if the token is to be assigned to a new token group, the token management system 300 confirms with the end user whether it is to create a new token group as shown at step 846. If a new token group is not to be created, then the process ends as shown at step 852. If a new token group is to be created, then the token management system 300 generates a token group identifier, as shown at step 848, and then assigns the universal token identifier for the newly created token to the newly created token group, as shown at step 850 and then the process ends as shown at step 854.

In an alternative embodiment, FIG. 8D illustrates a process for creating tokens and assigning tokens to new or existing token groups. This process commences at Step 856 and comprises specifying a token value at step 858, specifying a token expiration date at step 860, specifying a token type at step 862, specifying a token payer using an alias for identification at step 864, and specifying a token payee using an alias for identification at step 866. The token management system 300 confirms with the end user whether it is to assign the newly created token to an existing token group, as shown at step 868. In this embodiment, if the token is to be assigned to an existing token group, then the token group identifier is assigned to the newly created token as shown at step 874 and a universal token identifier is then generated for the token as shown at step 876 and the process, as shown at step 878. Alternatively, if the newly created token is not to be assigned to an existing token group, as shown at step 868, then the token management system 300 queries the end user to confirm whether it is to create a new token group, as shown at step 870. If it is not to create a new token group, then the process ends as shown at step 880. If it is to create a new token group, then the token management system generates a token group identifier as shown at Step 872, assigns the token group identifier to the newly created token as shown at Step 874 and then generates a universal token identifier for the newly created token as shown at Step 876. The process concludes after the universal token identifier is generated, as shown at Step 878.

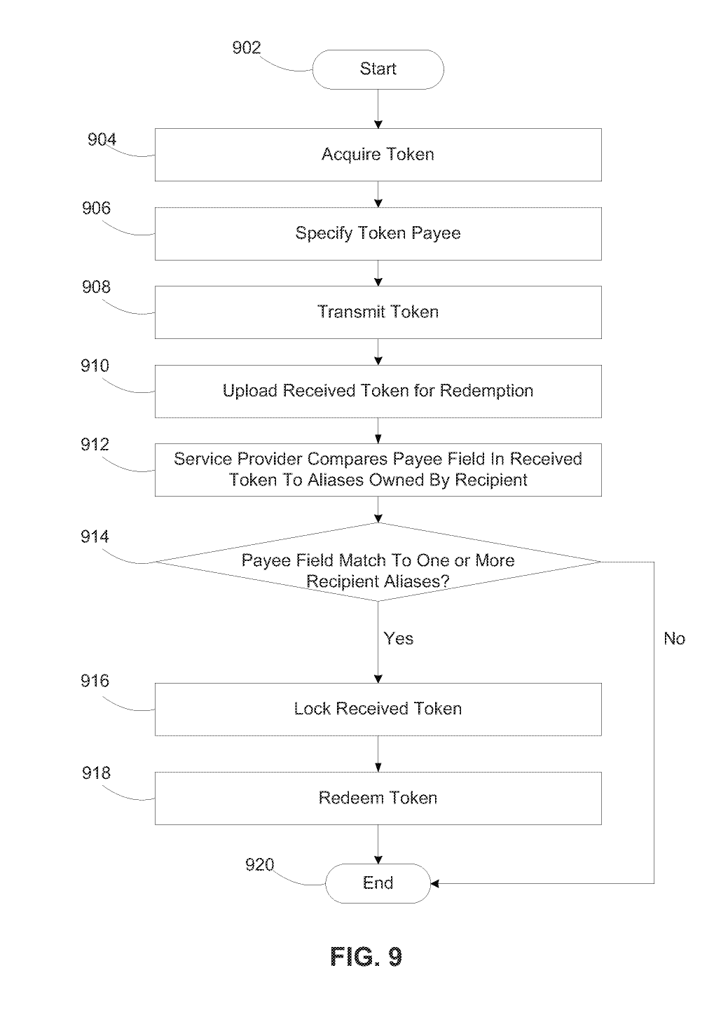

FIG. 9 is an illustration of a process for token redemption when the token to be redeemed includes payee identification information in an embodiment. The process starts at step 902 and comprises acquiring a token as shown at step 904, specifying the token payee as shown at step 906, transmitting the token as shown at step 908, uploading the received token for redemption as shown at step 910. Upon receipt of the uploaded token, the token management system will compare the payee field information in the received token to the aliases owned by the recipient which is attempting to redeem the token, as shown at step 912. A matching comparison is performed by the token management system 300, as shown as step 914, in which the content of the data in the payer field of the token is compared to the aliases stored in the user profile for the recipient who seeks to redeem the value of the token. If a match is confirmed by the token management system 300, then the received token will be locked as shown at step 916. The user-defined value of the token can be redeemed as shown at step 918 once the token is locked and made unavailable for locking or redemption by any other token redeemer. Upon redemption, the process concludes as shown at Step 920. On the other hand, if the matching comparison performed by the token management system does not result in a matching comparison then the token will not be locked and the process will end as shown at step 920.

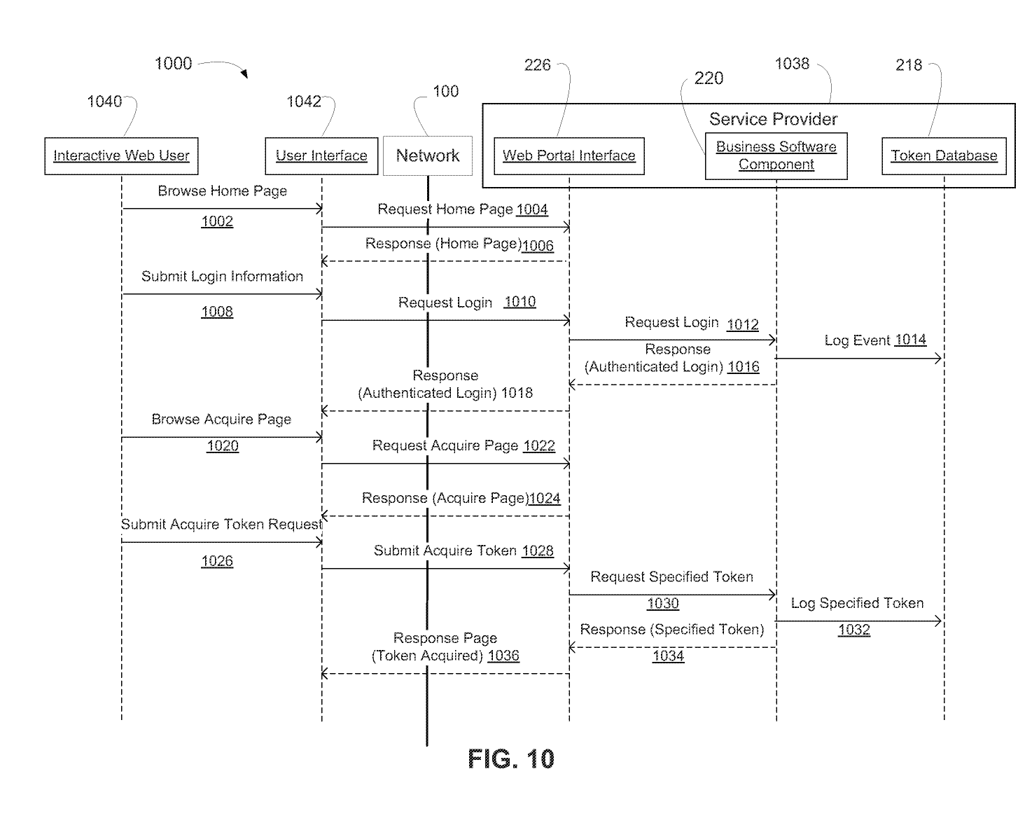

FIG. 10 illustrates an embodiment of a system and method for token acquisition. The system used in this embodiment includes a service provider 1038, a computer communications network 100 and a user interface 1042 used by an interactive web user 1040. The service provider 1038 maintains and operates the web portal interface 226 and the token management system 300. The service provider 1038 operates the service network 102 on which the token management system 300 is executed. In this embodiment, the token management system 300 includes business software component 220 and one or more token databases 218a, 218b. Web portal interface 226 communicatively interacts with the business software component 220 in the token acquisition process in response to message requests received from the user interface 1042 over the computer communications connection 100.

As depicted in this figure, interactive web user 1040 enters a request onto user interface 1042 to browse the home page of the token management system 300 operated by the service provider 1038 to commence the token acquisition process, which is shown at step 1002. Web portal interface 226 receives the browse request 1004 and responds 1006 with the home page for the token management system 300. Once displayed on the user interface 1042, the interactive web user 1040 supplies login information, as shown as step 1008. The user interface 1042 transmits the login request to the web portal interface 226, as shown as step 1010. Upon receipt of this request, web portal interface 226 transmits a user login request, as shown as step 1012, to the business software component 220 of the token management system 300. The business software component 220 subsequently sends a log event 1014 message to the token database 218. The token database 218 included in token management system 300 tracks all requests and queries and tracks the creation of new tokens and the acquisition and redemption of existing tokens. In the present embodiment, the token database 218 is represented as one database in which the user profile table and the token data table are stored. In alternative embodiments, multiple databases 218a, 218b can be implemented to manage the logging of events and the storage and retrieval of data for large numbers of interactive web users 1040.

After the log event message 1014 is transmitted from business software component 220 to the token database 218, the business software component 220 issues a response authenticating the user login request, as shown as step 1016. The web portal interface 226 in turn transmits a response indicating an authenticated login, as shown as step 1018, to the user interface 1042. Afterwards, the interactive web user 1040 enters a request on the user interface 1042 to browse the token acquisition page in the token management system 300, as shown as step 1020 to the user interface 1042. User interface 1042 transmits a request for display of the token acquisition, as shown as step 1022, which request is sent to web portal interface 226 of the token management system 300. Web portal interface 226 issues a response to the request for the token acquisition page, as shown as step 1024 and the web user 1040 subsequently submits a token acquisition request, as shown in step 1026. User interface 1042 submits the token acquisition request, as shown as step 1028 to web portal interface 226, and web portal interface 226 issues a request to the business software component 220 to create a token having the data specified by the interactive web user 1040 on the token acquisition page, as shown in step 1030.

In fulfilling the token acquisition request, the business software component 220 will generate a new token which will reside in the token database of the computer servers 104a, 104n of the token management system 300 and also produce a replicated copy of the token that can be acquired and downloaded onto the device operated by the interactive web user 1040. The token acquisition request is logged in the token database 218 as shown at step 1032. The business software component 220 generates the replicated token and displays a response page on the web portal interface 226 with the specified token which is now available for downloading and acquisition by interactive web user 1040, as shown at step 1034. The specified token that is available for download is the token which was created with all of the data specific to the token which was supplied by the interactive web user 1040 on user interface 1040 in communication with web portal interface 226. The response page 1036 is communicated to the user interface 1042 to enable the interactive web user 1040 to download and acquire the replicated token from the web portal interface 226.

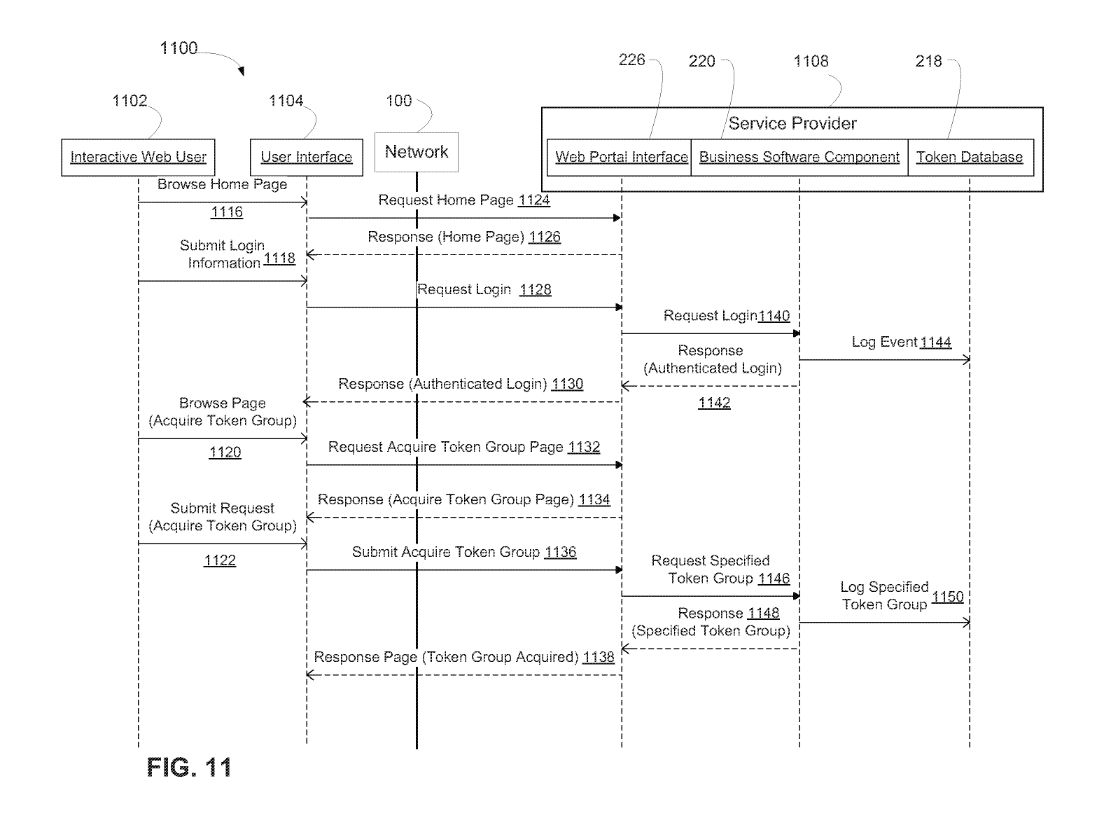

FIG. 11 is an illustration of an embodiment of a system and method for acquiring a token group. The system 1100 includes a service provider 1108, a computer communications network 100, interactive web user 1102 and a user interface 1104. In an embodiment, the user interface 1104 is an Internet web browser such as the Microsoft Internet Explorer browser or the Mozilla Internet browser. In alternative embodiments, the user interface 1104 is a custom browser for application specific devices (e.g., a browser for personal digital assistants, etc.). The service provider 1108 maintains and operates a service network 102, which includes one or more computer servers 104a, 104n for operating a token management system 300 and a web portal interface 226. The token management system 300 is comprised of a business software component 220 and a token database 218 in an embodiment. In alternative embodiment, the token database 218 is comprised of multiple databases 218a, 218b. In addition, a web portal interface 226 is provided to enable interactions between the interactive web user 1102 and the token management system 300. Interactive web user 1102 uses a user interface 1104 to send one or more requests over the network 100 to web portal interface 226 to create and acquire one or more token groups on the token management system 300.

In the present embodiment, interactive web user 1102 enters a request to browse the home page of the service provider 1108, as shown as step 1116. A command is entered on the user interface 1104 and a message is sent from the user interface 1104 to request the home page, shown in step 1124, which request is received by web portal interface 226. Web portal interface 226 issues a response message which provides the home page, step 1126. Interactive web user 1102 submits login information on the home page now displayed on the user interface 1104, as shown at step 1118. User interface 1104 sends a login request message, as shown at step 1128, to the web portal interface 226 and web portal interface 226 in turn sends a login request message to the business software component 220, as shown at step 1140. Business software component 220 sends a log event message, as shown at step 1144, to token database 218 and issues a response message authenticating the user's login, as shown at step 1142. Web portal interface 226 sends a response message authenticating the user login, as shown at step 1130, and afterwards interactive web user 1102 commences the browsing of the home page for the acquisition of a token group, as shown at step 1120.

Upon user authentication, interactive web user 1102 uses the user interface 1104 to send a message to the web portal interface 226 requesting the page on which a token group can be acquired, as shown at step 1132. In response, web portal interface 226 sends a response message which delivers the token group acquisition page to the user interface 1104, as shown at step 1134. Interactive web user 1102 submits a request to acquire a token group, as shown at step 1122, to user interface 1104, which is subsequently transmitted to web portal interface 226 over the computer communications network 100. A submit acquired token group message is transmitted from user interface 1104, as shown at step 1136, to web portal interface 226 which in turn sends a request message for a specified token group, as shown at Step 1146, to the business software component 220. Business software component 220 sends a message to token database 218 to log the specified token group, as shown at step 1150, and it also sends a response message to web portal interface 226 with information on the specified token group, as shown in step 1148. A response message is sent from web portal interface 226 to the user interface 1104 for viewing by interactive web user 1102. As a result of this response message, a response page is sent by web portal interface 226 to enable the interactive web user 1102 to view the token group acquisition page and to acquire the specified token group, as shown at step 1138.

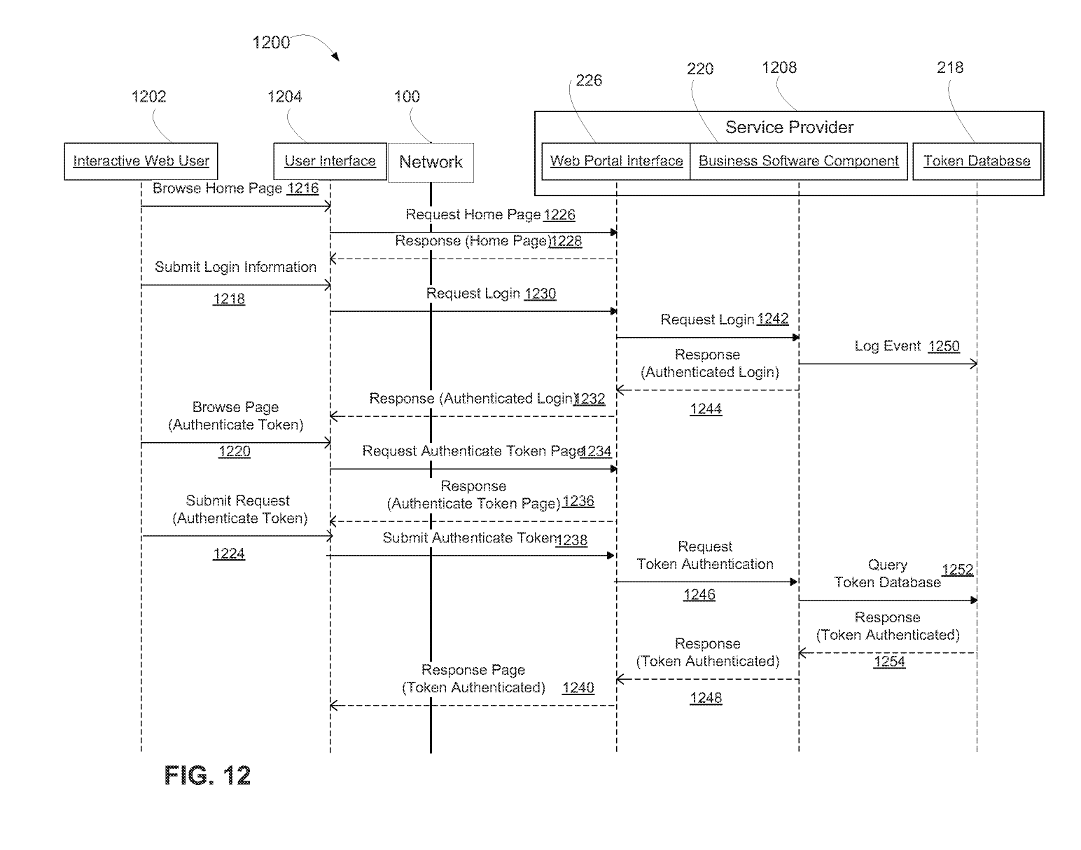

FIG. 12 illustrates a system and method for authenticating a token using a web portal interface. The system 1200 is comprised of a service provider 1208, a computer communications network 100, an interactive web user 1202 and a user interface 1204. In an embodiment, the user interface 1204 is an Internet web browser such as the Microsoft Internet Explorer browser or the Mozilla Internet browser. In an alternative embodiment, the user interface 1204 is a custom browser for application specific devices (e.g., a browser for personal digital assistants, etc.). Interactive web user 1202 uses user interface to 1204 to communicate over the computer communications 100 to the service provider 1208. Service provider 1208 maintains and executes the service network 102 using one or more computer servers 104a, 104n on which a token management system 300 and a web portal interface 226 are executed. The token management system 300 is comprised of business software component 200 and a token database 218 in an embodiment. In an alternative embodiment, the token management system 300 includes multiple token databases 218a, 218b for handling high volume token transactions.

In the present embodiment, interactive web user 1202 browses the home page, as shown at step 1216, operated by service provider 1208. Web user 1202 uses the user interface 1204 to send a request to the service provider 1208 for the home page of the token management system 300, as shown at step 1226. The home page request 1226 is received by web portal interface 226, which causes the interface 226 to generate and transmit a response which includes the home page, as shown in step 1228. Once received, web user 1202 submits login information, as shown at step 1218 using user interface 1204. User interface 1204 transmits the login request, step 1230, to web portal interface 226, which in turn generates a login request, as shown at step 1242, to business software component 220. Business software component 220 sends a log event message, at step 1250, to token database 218 and afterwards sends a response authenticating the login request, as shown at step 1244. In this embodiment, only registered users will have logins authenticated by the business software component 220. A registered user is a user having at least one alias registered in the token management system 300. Web portal interface 226 issues a response message authenticating the user login, as shown at step 1232, which response is sent to user interface 1224 for review by the interactive web user 1202.

After successful user authentication, interactive web user 1202 sends a request to browse an “authenticate token” page, as shown at step 1220, to the user interface 1204. Upon receipt of this request, the user interface 1204 transmits a separate request for the “authenticate token” page to the web portal interface 226, as shown at step 1234. In response, web portal interface 226 generates a response message which includes the “authenticate token” page, at step 1236. Upon receipt of this page, the web user 1202 submits a request to authenticate a specific token, as shown at step 1224, using user interface 1204. User interface 1204 in turn transmits a request to authenticate the token to the web portal interface 226, as shown at step 1238. Web portal interface 226 subsequently transmits a request for token authentication, as shown at step 1246 to the business software component 220. Upon receipt of this request, business software component 220 queries the token database, as shown at step 1252, to determine whether the token is authentic (i.e., valid). If the authentication is successful, the token database 218 issues a response message confirming the authenticated token, as shown at step 1254. Business software component 220 correspondingly sends a response message confirming the authentication of the submitted token, as shown at step 1248, to web portal interface 226. Web portal interface 226 transmits a response page confirming the token authentication, as shown at step 1240, to user interface 1204 for review by web user 1202.

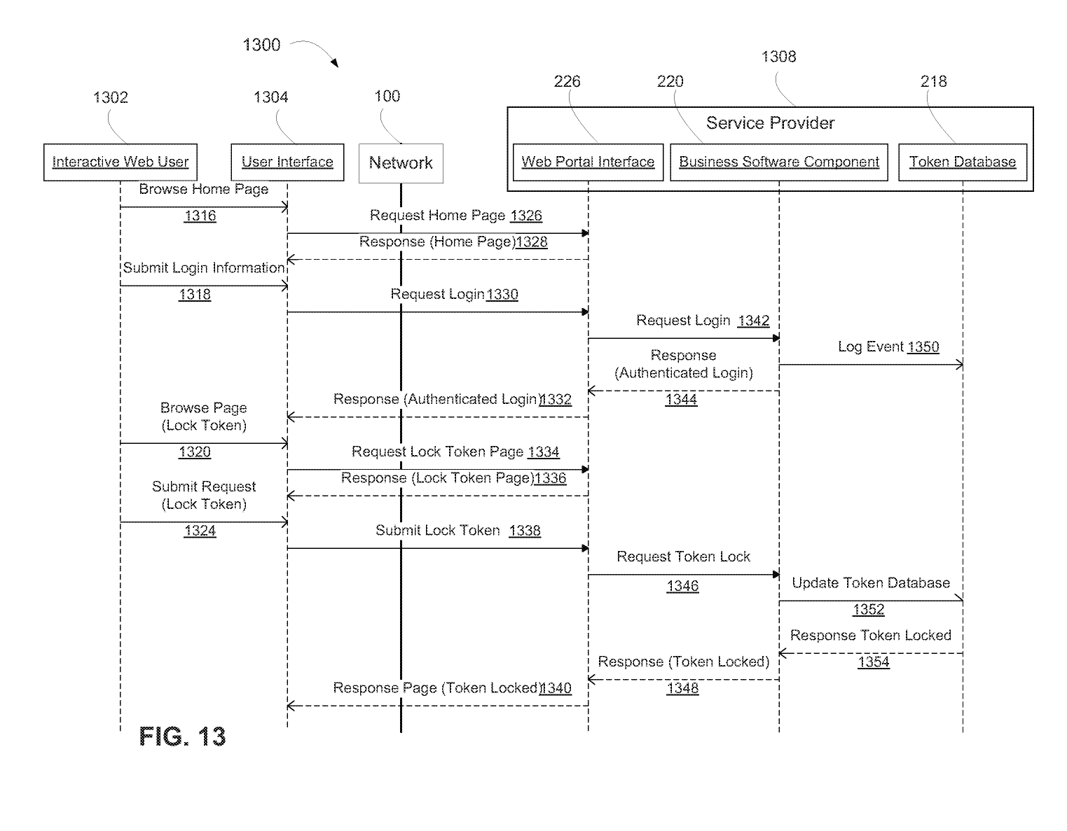

FIG. 13 illustrates an embodiment of a system and method for locking a token using a web portal interface 226. In this system 1300, a service provider 1308, a computer communications network 100, and a user interface 1304 are provided. In an embodiment, the user interface 1304 is an Internet web browser such as the Microsoft Internet Explorer browser or the Mozilla Internet browser. In alternative embodiments, the user interface 1304 is a custom browser for application specific devices (e.g., a browser for personal digital assistants, etc.). User interface 1304 is used by an interactive web user 1302 for sending one or more requests and messages to the service provider 1308. Service provider 1308 operates a service network 102, which includes one or more computer servers 104a, 104n for executing a token management system 300. Token management system 300 includes a business software component 220 and a token database 218 in an embodiment. In an alternative embodiment, the token management system 300 includes multiple databases 218a, 218b for handling higher volume token requests. The token management system 300 interacts with a web portal interface 226 to receive and respond to requests from interactive web user 1302 over computer communications network 100.

In the present embodiment, interactive web user 1302 browses the home page, at step 1316, using user interface 1304 and issues a request for the home page of the token management system 300, as shown at step 1326. Web portal interface 226 issues a response, which includes the home page, as shown at step 1328. Interactive web user 1302 submits login information as shown at step 1318 to the user interface 1304, and user interface 1304 transmits a request login message, as shown at step 1330, to web portal interface 226. Web portal interface 226 transmits a request login message, step 1342, to business software component 220, which in turn transmits a log event message, as shown at step 1350 to the token database 218. The business software component 220 also sends an authenticated login response message after completing a user authentication process, as shown at step 1344, to web portal interface 226 and this interface 226 sends a response message confirming an authenticated login, as shown at step 1332. Interactive web use 1302 sends a new message to browse the token management system 300 for the lock token page, as shown at step 1320. This message is sent to user interface 1304, which in turn generates and sends a message requesting the lock token page, as shown at step 1334, which message is transmitted to web portal interface 226. Web portal interface 226 replies as a response with the lock token page, as shown at step 1336. Web user 1302 submits a request to lock a token, as shown at step 1324, to user interface 1304 and, in response the user interface submits a lock token request, as shown at step 1338 to web portal interface 226. Web portal interface 226 transmits the request for a token lock, as shown at step 1346, to business software component 220 and business software component 220 subsequently issues an update of the token status to the token database 218. More specifically, business software component 220 issues an update message specifically changing the status of the token from “active” to “locked”, as shown at step 1352. In response to the change in token status, token database 218 generates a response message confirming the locked status of the token, as shown at step 1354. Business software component 220 sends a response message, as shown at step 1348, specifying the locked status of the token, which message is transmitted to web portal interface 226. The web portal interface 226 transmits a response page confirming the locked status of the token, as shown at step 1340, to user interface 1304 for review by the interactive web user 1302.

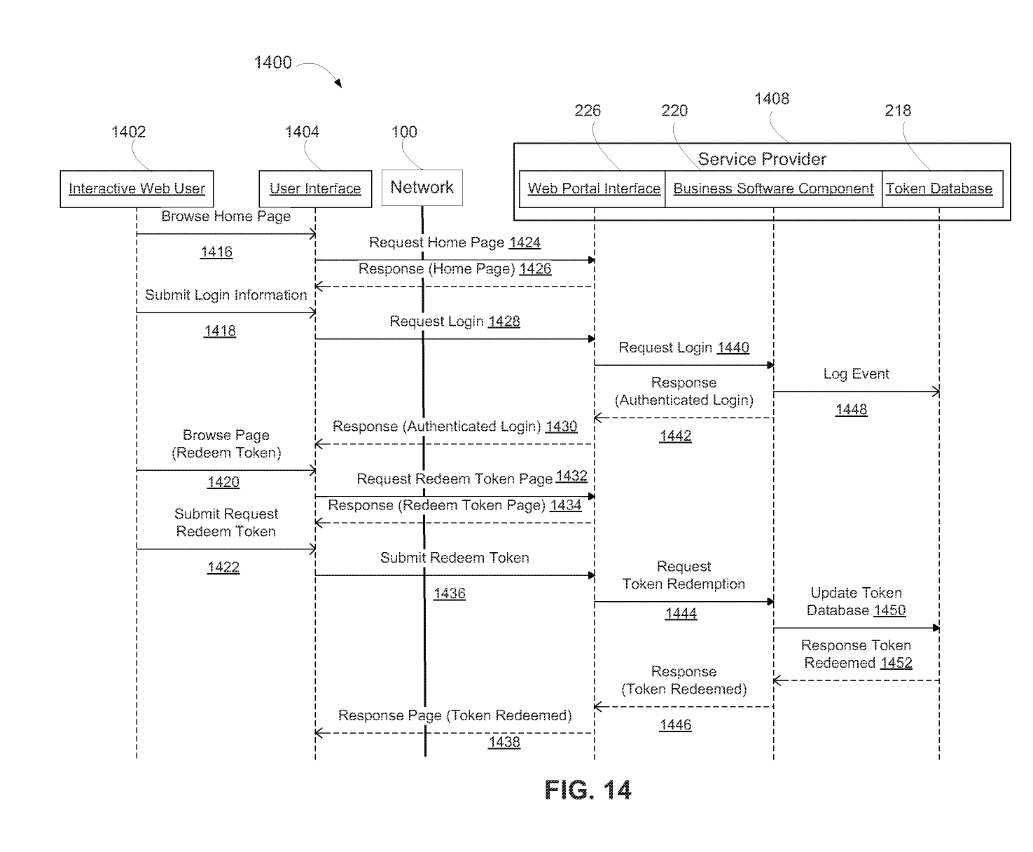

FIG. 14 illustrates an embodiment of a system and method for redeeming tokens. This system 1400 includes a service provider 1408, a computer communications network 100 and a user interface 1404. In an embodiment, the user interface 1104 is an Internet web browser such as the Microsoft Internet Explorer browser or the Mozilla Internet browser. In alternative embodiments, the user interface 1104 is a custom browser for application specific devices (e.g., a browser for personal digital assistants, etc.). Interactive web user 1402 uses user interface 1404 to communicate over computer communications network 100 to a token management system 300 operated by service provider 1408. The token management system 300 includes a business software component 220 and a token database 218. Service provider 1408 also operates and executes a web portal interface 226, which serves to receive requests from interactive web user 1402 for processing by token management system 300.

As shown in this embodiment, interactive web user 1402 uses user interface 1404 to submit a request to browse the home page 1416 of the token management system 300. User interface 1404 receives this browse home page request 1416 and transmits a message to web portal interface 226 requesting the display of the home page for the token management system 300, as shown at step 1424. Web portal interface 226 responds with a message which includes the home page of the token management system 300, as shown at step 1426, which is displayed on the user interface 1404. Upon receipt of the home page, interactive web user 1402 submits login information, as shown at step 1418, on user interface 1404 which information is subsequently transmitted to the web portal interface 226, as shown at step 1428. Web portal interface 226 transmits a separate user login request, as shown at step 1440, to business software component 220 upon receipt of the request from user interface 1404. The business software component 220 transmits a log event message, as shown at step 1448, to token database 218 to maintain an active log of all user logins. Business software component 220 issues a response confirming the authenticated login of the interactive web user 1402, as shown at step 1442, only if the login information provided by interactive web user 1402 is identical to one or more aliases that are stored in the token database 218. Business software component 220 executes a matching comparison process to determine whether the supplied alias (e.g., user email address, etc.) of the requesting user matches one or more of the stored aliases for the user. If confirmed, the web portal interface 226 transmits an authenticated login response, as shown at step 1430 to the user interface 1404.

After confirmation of an authenticated user login, interactive web user 1402 submits a request using user interface 1404 to browse the “redeem token” page of the token management system 300, as shown at step 1420. In response, the user interface 1404 transmits a request for a redeemed token page, as shown at step 1432, to web portal interface 226. Web portal interface 226 transmits a response to the request which includes the redeemed token page, as shown at step 1434, which enables interactive web user 1402 to submit a request to redeem a token as shown at step 1422. The request to redeem a token is placed on user interface 1404 and transmitted to web portal interface 226, as shown at step 1436. Web portal interface 226 transmits the request for token redemption as shown at step 1444 to business software component 220 and this component in turn issues an update token message, as shown at step 1450 to ensure the status of the stored token in the token database 218 is changed to reflect its current “redeemed” status. Token database 218 issues a response confirming the status change of the token as being “redeemed,” as shown at step 1452 which response is sent to business software component 220. Business software component 220 in turn sends a token “redeemed” response, as shown at step 1446 to web portal interface 226, which in turn generates and displays a response page on the user interface 1404 confirming that the submitted token has been redeemed, as shown at step 1438.

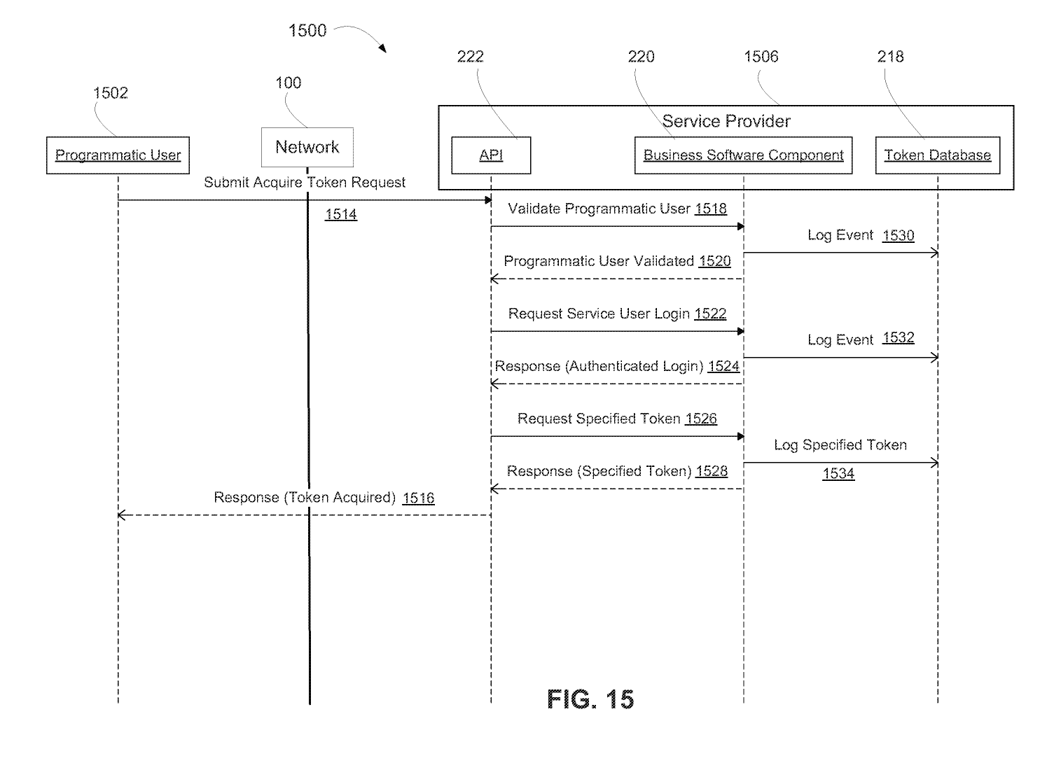

FIG. 15 is illustrative of a system and method for acquiring a token using a computer program application. The system 1500 is comprised of a service provider 1506 and a computer communications network 100. In the system 1500, a programmatic user 1502 using a computer program application executes a subroutine or other system call which submits a request to acquire a token, as shown at step 1514, to an application programming interface (an “API”). In the present embodiment, the API is accessible over a secure communication connection, such as a communication connection using a cryptographic protocol such as the Secure Sockets Layer protocol, and is referred to as a “Secure API” 222. Service provider 1506 manages the operation of a service network 102 which includes one or more computer servers 104a, 104n on which a token management system 300 and the API are executed.

The token management system 300 is comprised of a business software component 220 and one or more token databases 218a, 218b. In the illustrated embodiment, a token database 218 is shown; however, in an alternative embodiment the token database 218 can be implemented using multiple databases when very large data sets are required to track, store and manage data for high volume token transactions. In this system 1500, Secure API 222 submits a request to validate the programmatic user in response to the request received from the programmatic user 1502, as shown at step 1518, to the business software component 220. In order to validate the programmatic user 1502, the business software component 220 performs a matching comparison between the API key supplied by the programmatic user 1502 and the key stored in the token database 218. In addition, the business software component 220 will evaluate the identity of the programmatic user 1502 that seeks to gain access to the token management system using a matching comparison to determine if an alias exists for the programmatic user 1502 in the token database 218. In performing this matching comparison to validate the identity of the programmatic user 1502, the business software component 220 submits a log event request, as shown at step 1530, to the token database 218. If the matching comparison is successful and the identity of the programmatic user 1502 is validated, a response is sent to the Secure API 222, as shown at step 1520. After the identity is validated, the Secure API 222 transmits a request for a service user login, as shown at step 1522 which includes both the user identification and the user security password in an embodiment. This request is sent to business software component 220 which also transmits a log event message, as shown at step 1532, to the token database 218. The business software component 220 performs an authentication process based on both the user identification and the user security password and returns a response confirming an authenticated login, as shown at step 1524, if one or more aliases match the alias provided by programmatic user 1502. Subsequently, Secure API 222 submits a request for specified token, as shown at step 1526, to business software component 220. This request includes the specific parameters and data that will be unique to the token to be acquired (e.g., token value, token expiration date, token payee, etc.). The business software component 220 logs this request for the specified token, as shown at step 1534, in the token database 218. Since the request to acquire a token has been received from an authenticated programmatic user, the business software component 220 will transmit a response with the specified token which confirms the availability of the token in the token management system 300 for acquisition, as shown at step 1528. The response including the specified token 1528 is provided to the Secure API 222 which in turn transmits a response to the programmatic user 1502 which includes the acquired token, as shown at step 1516. Upon receipt of this response, the acquired token can be downloaded on to a sending device 106 by the programmatic user 1502 over the computer communications network 100.

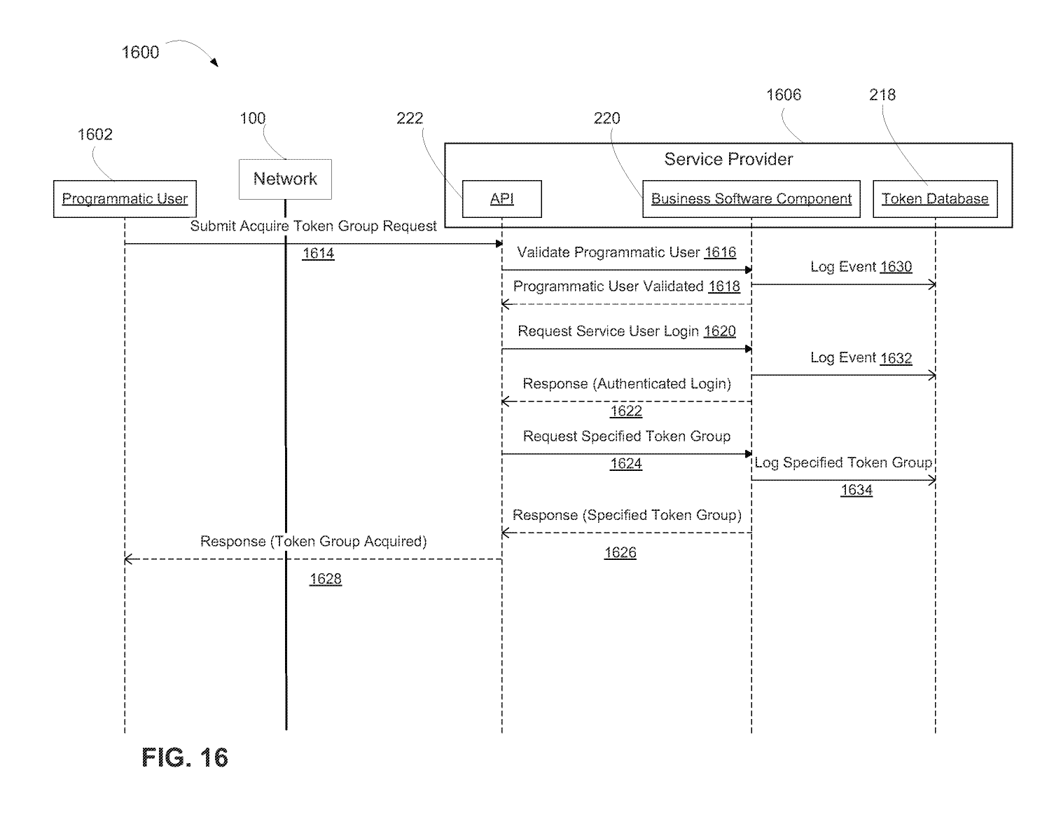

FIG. 16 is an illustration of a system and method for the programmatic acquisition of token groups in an embodiment. In this system 1600, a service provider 1606 and a computer communications network 100 are provided. Programmatic user 1602 submits requests and receives responses over a computer communications network 100 to and from the service provider 1606 for the acquisition of token groups. The service provider 1606 includes an Application Programming Interface (API) 222 and a token management system 300. The token management system 300 is comprised of a business software component 220 and a token database 218.

In operation, the programmatic user 1602 submits a request to acquire a token group, as shown at step 1614, to API 222. In the present embodiment, the API is accessible over a secure communication connection, such as a communication connection using a cryptographic protocol such as the Secure Sockets Layer protocol, and is referred to as a “Secure API” 222. Upon receipt of the token group acquisition request, the Secure API 222 generates and sends a message to validate the programmatic user, as shown at step 1616, to the business software component 220. The business software component 220 logs the event, as shown at step 1613, in the token database 218 and subsequently issues a response confirming the validation of the programmatic user if the identity of the programmatic user is successfully validated against data for the user in the token database 218, as shown at step 1618. After receipt of the validation from the business software component 220, the Secure API 222 submits a request for a service user login, as shown at step 1620, to the business software component 220. The business software component 220 again sends a log event message, as shown at step 1632, to the token database 218 and also generates a response which is transmitted to the Secure API 222 as shown at step 1622. If the login was successful, the response 1622 will confirm the login of an authenticated user into the business software component 220 of the token management system 300. Afterwards, the Secure API 222 generates and sends to the business software component 220 a request for a specified token group, as shown at step 1624. In specifying a token group, the programmatic user 1602 requests the creation of a token group identifier which will be stored in a data field for each token to be included in the token group. The identifier is unique to the token group and will be generated internally by the business software component 220.

The business software component 220 includes implementations of one or more business rules for processing requests for the creation, acquisition, authentication, locking and redemption of tokens and token groups. As shown here, the business software component 220 logs each specified token group in the token database 218 using an event message and then transmits a response with the specified token group, as shown at step 1626, to the Secure API 222. Once received, the Secure API 222 issues a response to the programmatic user 1602 confirming that a token group has been acquired, as shown at step 1628.

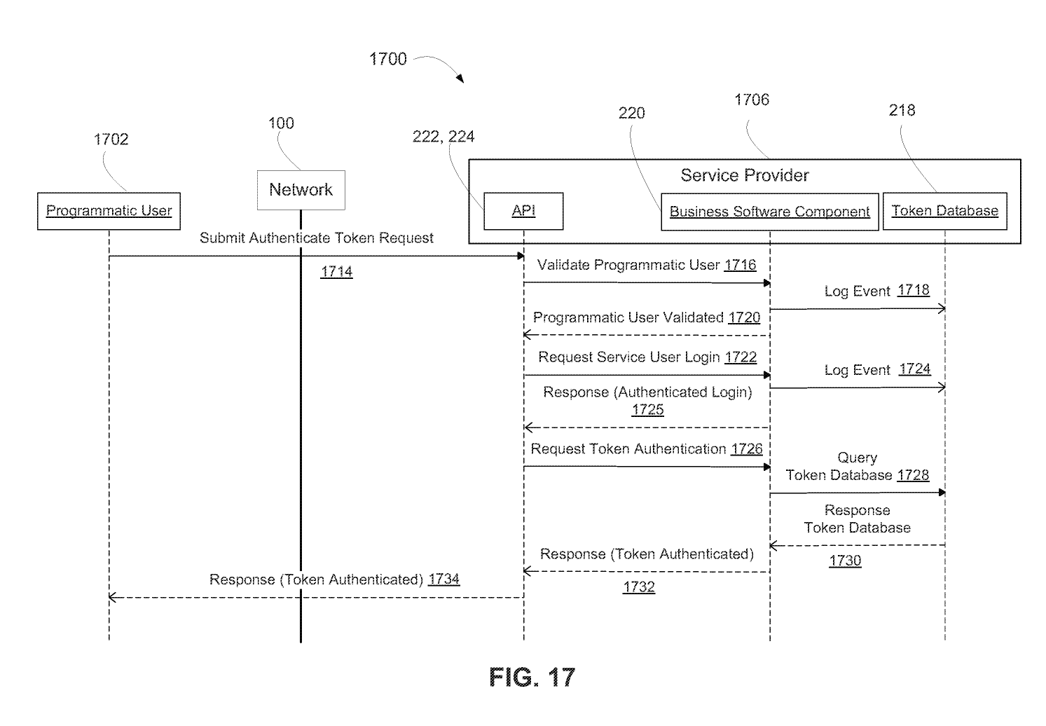

FIG. 17 is an illustration of a system and method for the programmatic authentication of a token in an embodiment. In this system 1700, a service provider 1706 and a computer communications network 100 are provided. Programmatic user 1702 submits and receives messages over the computer communications network 100 to and from the service provider 1706. The service provider 1706 operates and executes the service network 102 which is comprised of one or more computer servers 104a, 104n for executing a token management system 300. The token management system 300 is comprised of a business software component 220 and the token database 218. The service provider 1706 also operates and executes one or more application programming interfaces. In an embodiment, the programmatic user 1702 submits requests to authenticate one or more tokens, as shown at step 1714 over a clear-text communication connection to an application programming interface operated by the service provider 1706. In this embodiment, the receipt of a request over a clear-text communication channel involves communication with a “Public API” 224. In an alternative embodiment, the programmatic user 1702 submits requests to authenticate one or more tokens, as shown at step 1714, over a secure communication connection to a “Secure API” 224.

In operation, after an authentication request 1714 is received, the API 222, 224 generates a message to validate the programmatic user, shown at step 1716, which is sent to the business software component 220. This validation request is logged in the token database 218, as shown at step 1718, and if the user is validated, the business software component 220 generates a reply confirming the programmatic user validation, as shown at step 1720. Validation of a programmatic user 1702 involves a matching comparison between a unique identifier for the programmatic user 1702 and at least one alias stored in the token database 218 for the programmatic user 1702. The API 222, 224 subsequently transmits a request for a service user login, as shown at step 1722, to the business software component 220. At this point, the business software component 220 transmits another log event message to update the log of activities in the token database 218 related to the authentication request, as shown at step 1724. A response confirming the authentication the service user login request 1722 received from the API 222, 224 will be sent from the business software component 220 if it confirms a match between a unique user identifier, a user security password and corresponding data stored in the token database 218 for the programmatic user 1702, as shown at step 1725.

After completion of an authenticated login and receipt of a response by the API 222, 224 confirming the authentication of the login, step 1725, the API 222, 224 submits a request to authenticate the token received from the programmatic user 1702, as shown at step 1726. In responding to this request, the business software component 220 performs a field by field comparison of data included in the token to data stored in the token database 218 corresponding to the token received from the programmatic user 1702. In performing this comparison, the business software component 220 performs a query of a token database as shown at step 1728. If this query is successful, the token database 218 generates a response confirming the authentication of the token, as shown at step 1730, which is received by the business software component 220. The business software component 220 then transmits a token authentication response, as shown at step 1732, to API 222, 224. The receipt of the response from the business software component 220 will in turn cause the API 222, 224 to transmit a “token authenticated” response 1734 to the programmatic user 1702.

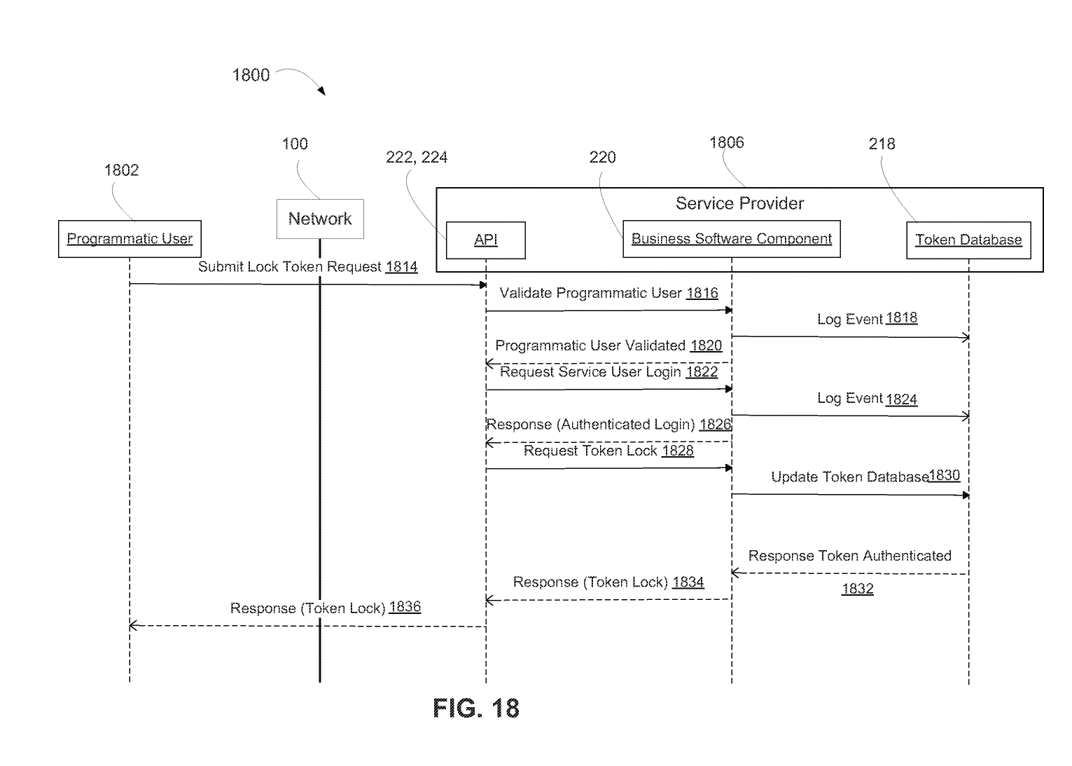

FIG. 18 is an illustration of a system and method for token locking in an embodiment. In this system 1800, a service provider 1806 and a computer communications network 100 are provided. An end user using a computer program application executes a subroutine or other system call which submits requests to and responses from an application programming interface operated by the service provider 1806. In executing this computer program, the end user is referred to as a “programmatic user” since the actual requests are made by a running computer program, rather than the end user per se. Thus, the programmatic user 1802 communicates requests and receives responses over computer communications network 100 from service provider 1806. Service provider 1806 is comprised of an application programming interface, a business software component 220 and a token database 218. The business software component 220 and the token database 218 are included in a token management system 300. In an alternative embodiment, the token database 218 is comprised of multiple databases 218a, 218b for handling high volume token transactions. Service provider 1806 manages and executes a service network 102 on which the token management system 300 is executed. Computer servers 104a, 104n are used to execute the business software component 220 and the token database 218 and the application programming interface (“API”). In an embodiment, the programmatic user 1802 communicates over a clear-text communication connection to an application programming interface. In this embodiment, the application programming interface is referred to as a “Public API” 224. In an alternative embodiment, programmatic user 1802 communicates over a secure communication connection, such as a connection using the Secure Sockets Layer protocol, over the computer communications network 100 to an application programming interface. In this alternative embodiment, the application programming interface is referred to as a “Secure API” 222.

The token lock process commences with the programmatic user 1802 submitting a request to lock a token, as shown at step 1814, which request is transmitted to the API 222, 224. The API in turn generates a request to validate the programmatic user 1802, as shown at step 1816, which request is sent to the business software component 220. The business software component 220 logs the validation request by sending an event message, as shown at step 1818, to the token database 218. In addition, the business software component 220 performs a process to validate the programmatic user 1802 which includes comparing the API key provided by the programmatic user 1802 to the API key stored in the token database and associated with the programmatic user 1802. If the API key is valid, then the business software component 220 issues a reply confirming user validation, as shown at step 1820.

After user validation, the API 222, 224 transmits a request for a service user login as shown at step 1822. The business software component 220 logs this new service user login request, as shown at step 1824, in the token database 218 by sending a log event message. The business software component 220 sends a response confirming the authentication of the user login, as shown at step 1826, upon successful authentication of the service user, which is the end user who controls the operation of the computer program seeking access to the token management system 300. Authentication of the service user comprises comparing a unique identification for the end user to an alias for the end user stored in the token database 218.

Once the service user is authenticated, the API 222, 224 sends a request to lock the submitted token, as shown at step 1828, to the business software component 220 which subsequently sends an update to the token database, as shown at step 1830, which resets the status of the token from “active” to “locked.” After changing token status, the token database 218 sends a response confirming the authentication of the token, as shown at step 1832, to the business software component 220. The business software component 220 then sends a response confirming the token lock, as shown at step 1834, to the API 222, 224. After receipt of this response, the API 222, 224 sends a response to the programmatic user 1802 confirming the token lock, as shown at step 1836.

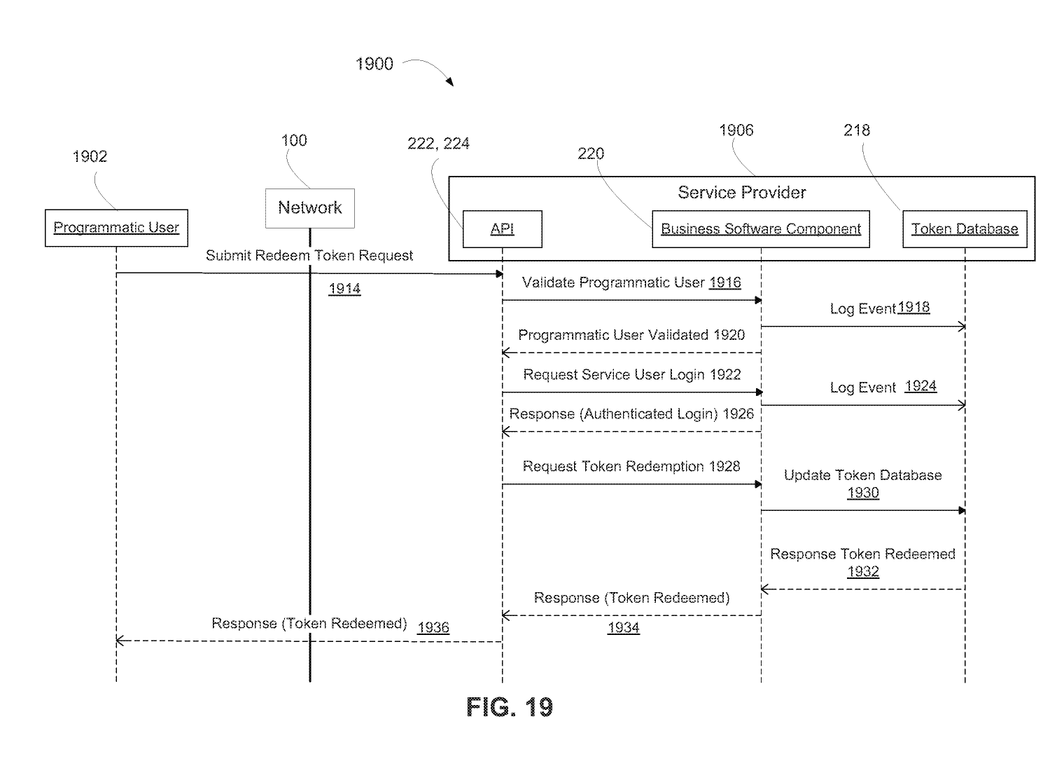

FIG. 19 is an illustration of a system and method for programmatic token redemption in an embodiment. In this system 1900, a service provider 1906 and a computer communications network 100 are provided. A programmatic user 1902 submits requests and receives responses from an application programming interface (API) maintained and operated by the service provider 1906. An end user using a computer program application executes a subroutine or other system call which submits requests to and responses from an application programming interface operated by the service provider 1806. In executing this computer program, the end user is referred to as a “programmatic user” since the actual requests are made by a running computer program, rather than the end user per se. Additionally, in one embodiment, the API is accessible over a clear-text communication connection and is referred to as a “Public API” 224. In an alternative embodiment, the API is accessed over a secure communication channel using a secure cryptographic protocol such as the Secure Sockets Layer protocol and is referred to as a “Secure API” 222.

The service provider 1906 manages the operation of a service network 102 which includes one or more computer servers 104a, 104n on which a token management system 300 and the API 222, 224 are executed. The token management system 300 operated by the service provider 1906 executes a business software component 220 and a token database 218. In an alternative embodiment, the service provider 1906 maintains and executes multiple databases 218a, 218b which handle high volume token transactions over large data sets. Although this description refers only to the embodiment using a single token database 218, it should be understood by those of ordinary skill in the art that multiple token data tables and user profile tables can be stored, organized and updated using large-scale database management techniques.

The programmatic token redemption process commences with the programmatic user submitting a “redeem token” request 1914 over the computer communication network 100 to the API 222, 224. Upon receipt of this token redemption request 1914, the API 222, 224 sends a request to validate the programmatic user, as shown at steps 1916, to the business software component 220. The business software component 220 sends a log event message, as shown at step 1918, to the token database 218 and subsequently issues a programmatic user validation, as shown at step 1920, if there is a match between the API key used by programmatic user 1902 for the token redemption request and the API key stored in the token database 218 for the programmatic user 1902. The API 222, 224 subsequently issues a service request to enable the programmatic user 1902 to login, as shown as step 1922, to the business software component 220 and the business software component 220 subsequently issues a message to log the service user login request event into the token database 218, as shown at step 1924. The business software component 220 returns a response confirming an authenticated service user login, as shown at step 1926, if a matching comparison process confirms a match between the user identification supplied by the programmatic user 1902 and one or more aliases stored in the token database 218 for the end user. Upon successful service user authentication, the API 222, 224 transmits a request for token redemption, as shown at step 1928. The business software component 220 receives the request for token redemption, shown at step 1928, and sends a message to the token database 218, as shown at step 1930, to change the status of the token from “locked” to “redeemed.” The token database 218 sends a response confirming token redemption, as shown at step 1932, which serves to confirm that the user-defined value of the token has been transferred from an interim holding account in the token database 218 to the user account for the service user. After receipt of the token redemption response, shown at step 1932, the business software component 220 sends a response to the API 222, 224 indicating that the token has been redeemed, as shown at step 1934. The API 222, 224 generates a response message which is sent to the programmatic user 1902 which confirms that the token status is “redeemed” and that the user-defined value has been transferred to the service user's, as shown at step 1936.

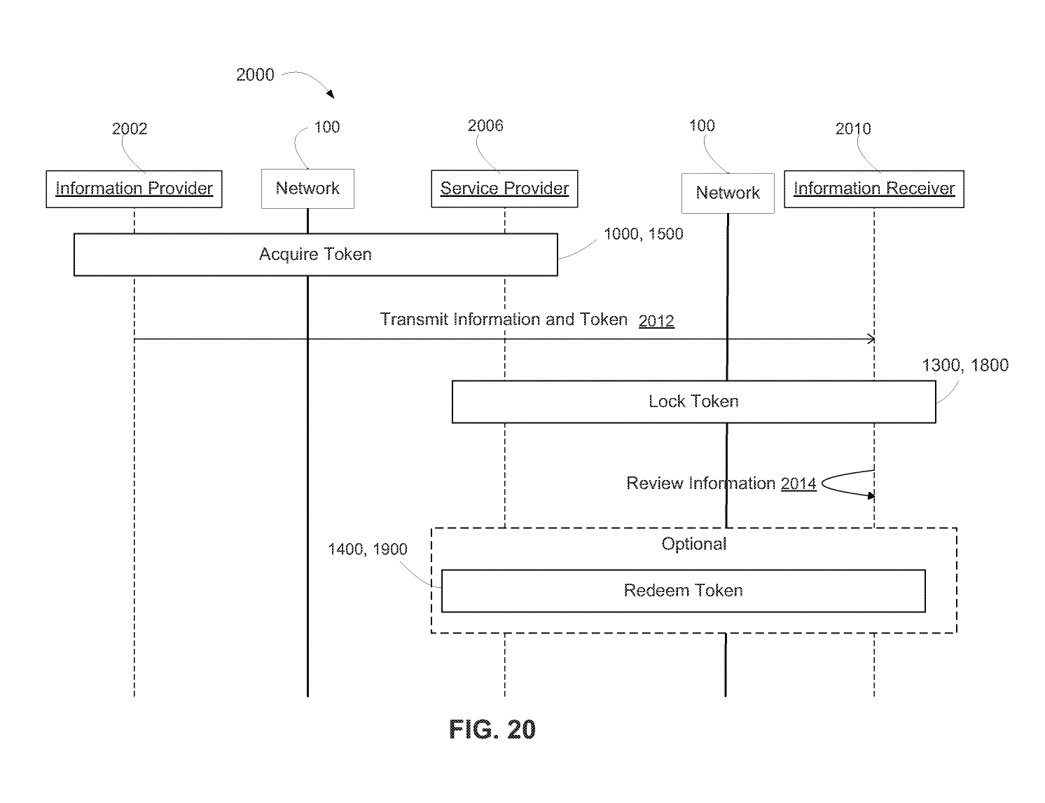

FIG. 20 illustrates a system and method for execution of an information insurance scenario in an embodiment. In this system 2000, a service provider 2006, a first communications network 100, a second communications network 110, an information receiver 2010 and an information provider 2002 are provided. The information provider 2002 performs the token acquisition process 1,000, 1,500 and subsequently transmits information and a token over the second communications network 110, as shown at step 2012, to an information receiver 2010. The information provider 2002 performs a first token acquisition process 1000 if the acquisition request is provided on the web portal interface 226, while a second token acquisition process 1500 is performed if the token acquire request is made programmatically using a Secure API 222. The information receiver 2010 performs the process for locking a token 1300, 1800, the locking process depending on whether the request to lock a token was received on the web portal interface 226 or on an API 222, 224, and subsequently reviews the transmitted information, as shown as step 2014. If the received information is deemed to have little to no value or does not satisfy a criterion established by the information receiver 2010, then the information receiver 2010 can redeem the token value using a token redemption process 1,400, 1,900. The type of redemption process used depends on whether the redemption request is received on the web portal interface 226 or on an API 222, 224.

In this system 2000, the information provider 2002 and the information receiver 2010 can communicate over public computer communication connections or secure computer communication connections using a cryptographic protocol such as the Secure Sockets Layer protocol. If a communication occurs over a public computer communication connection, then the process depicted in FIG. 10 will be followed. If the information provider 2002 communicates over a secure communication connection then the process illustrated in FIG. 15 will be followed for a programmatic user. Likewise, the information receiver 2010 can communicate over a public computer communications connection using the process illustrated in FIG. 13 or communicate over a secure computer communications connection using the process illustrated in FIG. 18. The information receiver 2010 can also communicate a request to redeem the token value over either a public computer communications connection or a secure computer communications connection. If communication is performed over a public connection, then the process illustrated in the FIG. 14 will be followed. If communication is pursued over a secure communication connection then the process illustrated in FIG. 19 for token redemption will be followed.

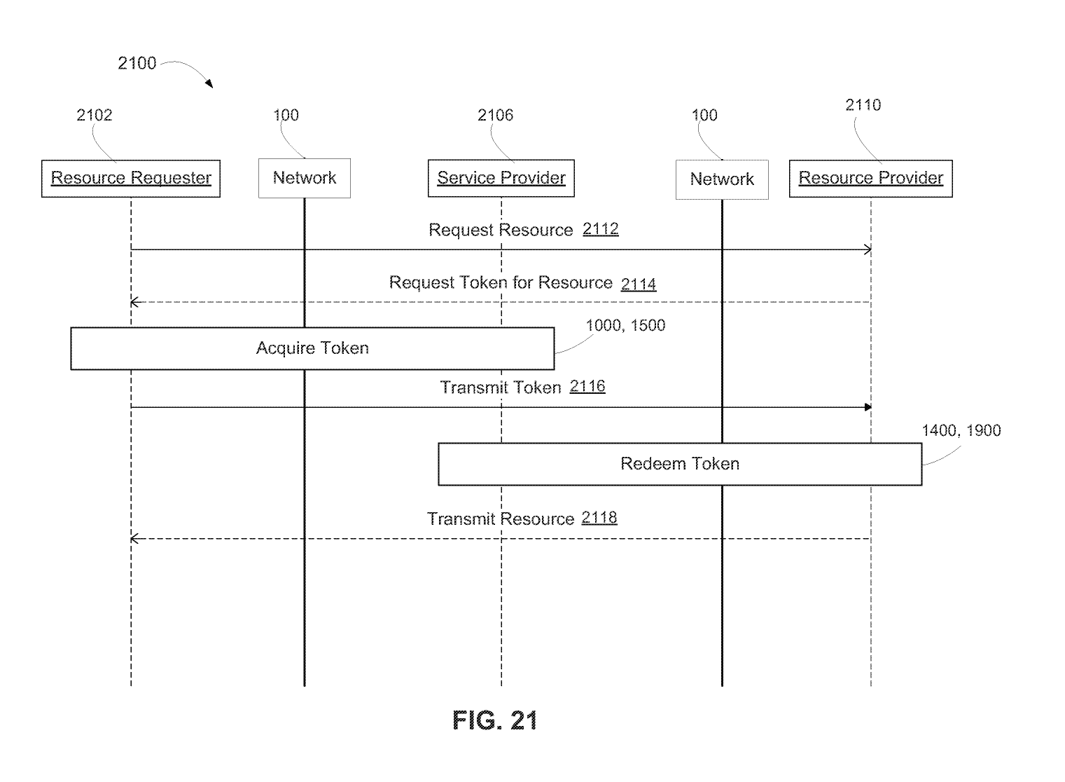

FIG. 21 illustrates a system and method for the payment of a resource in an embodiment. The resource can be either a product or service, such as technical or informational service offered by researchers, professionals or specialized advisors. In this system 2100, a service provider 2106, a resource provider 2110, a resource requester 2102, a first communications network 100, and second communications network 110 are provided. Resource requester 2102 initially sends a message over the second communication network 110 requesting a resource, as shown at step 2012, to the resource provider 2110. In response, the resource provider 2110 sends a message over the second communication network 110 requesting a token for the resource, as shown at step 2014, from the resource requester 2102. The resource requester 2102 executes the token acquisition process illustrated in FIG. 10 or FIG. 15 depending on whether communications are performed over a public communications connection or a secure communications connection. Once the token is acquired by the resource requester 2102, the token is transmitted over the second communication network 110 to the resource provider 2110, as shown at step 2016. The token value reflects the value that is available for voluntary redemption by the resource provider 2110 based on the level of need or desire for the resource expressed by the resource requester 2102. Thus, the resource provider 2110 can elect to redeem the token value using the process set forth in either FIG. 14 or FIG. 19, depending on the type of communication connection and the manner in which the request for the resource was provided (i.e., on the web portal interface 226 or on an API 222, 224), and subsequently transmits the resource over the second communication network 110, as shown at step 2018, to the resource requester 2102.

In one embodiment of the system 2100, the resource requester 2102 makes payment to the resource provider 2110 using token transmissions 2116 to ensure periodic access to a resource (e.g., daily, weekly, monthly or annual access). The user-defined value of each transmitted token 2116 is a “micro-payment” from the resource requester 2102 for access to a desired resource. The desired resource is a newspaper in one embodiment. With each request, the resource provider 2110 can accept or reject the user-defined value offered as payment for access to the resource, and the resource requester 2102 can continue to offer such value for voluntary redemption by the resource provider 2110. In this way, resource providers 2110 can vary the value of access to a resource based on their established criterion over the periods of time for which resource requesters 2102 seek access.

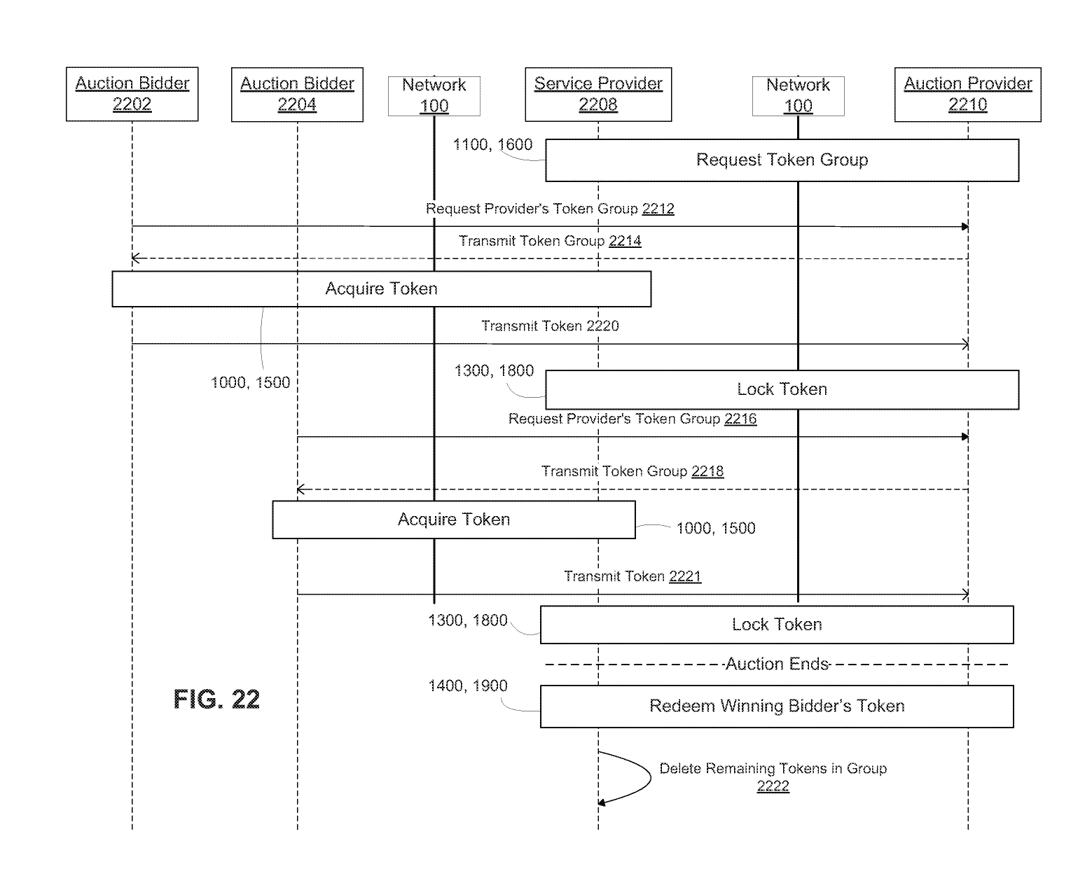

FIG. 22 illustrates an embodiment of a system and method for performing an auction in an embodiment. In this scenario, a service provider 2208, a first communications network 100, a second communication network 110, an auction provider 2210, a first auction bidder 2202 and a second auction bidder 2204 are provided. It should be well recognized by those of ordinary skill in art that a sealed bid auction of the type illustrated in this FIG. 22 may include auction bids from multiple bidders but for the sake of illustrating the operability of this embodiment, this figure illustrates two auction bidders. Initially, the auction provider 2210 requests a token group from the service provider 2208 using the process illustrated in FIG. 11 or FIG. 1600 depending on whether the request is made over a public or secure communications connection, or on the web portal interface 226 or on an API 222, 224 operated by the service provider 2208. The first auction bidder 2202 sends a message over the second communication network 110 requesting the auction provider's token group, as shown at step 2212, and the auction provider 2210 subsequently transmits over the second communication network 110 the token group information, as shown at step 2214, to first auction bidder 2202. In response, the first auction bidder 2202 acquires a token using either the process illustrated in FIG. 10 or FIG. 15 for acquiring tokens. An auction of the type contemplated herein can be initiated by auction bidders using either the web portal interface 226 or either of the application programming interfaces 224, 222. After acquisition of a token, the first auction bidder 2202 transmits a token over the second communication network 110, as shown at step 2220, to the auction provider 2210. The auction provider 2210 subsequently locks the received token using the process illustrated in FIG. 13 or in FIG. 18 and the locked token confirms the first sealed bid from an auction bidder.

The second auction bidder 2204 submits a request for the auction provider's token group over the second communication network 110, as shown at step 2216, to the auction provider 2210. The second auction bidder 2204 will become the second auction bidder in the sealed bid auction contemplated in this scenario upon submission of a token having a bidder-assigned value. In response to the request for the provider's token group, the auction provider 2210 transmits the token group over the second communication network 110, as shown at step 2218 to, the second auction bidder 2204. Upon receipt of the token group information, the second auction bidder 2204 acquires a token in the token group from the token management system 300 using either the process illustrated in FIG. 10 or in FIG. 15 depending on the communication connection used for acquisition of the token and on the manner in which the token request is made (i.e., on the web portal interface 226 operated by the service provider 2208 or programmatically using an API 222, 224). The second auction bidder 2204 subsequently transmits the acquired token over the second communication network 110, as shown at step 2221, to the auction provider 2210. The auction provider 2210 subsequently locks the second token using either the process illustrated in FIG. 13 or in FIG. 18 depending on whether the process is performed over a public or secure communication connection as well as whether it was provided using the web portal interface 226 or either one of the APIs 222, 224. Upon completion of the submission of all bids from auction bidders, the first auction provider 2210 will redeem the token provided by the winning bidder using the redemption process illustrated in either FIG. 14 or FIG. 19. After redemption of the winning bidder's token value, all other tokens in the same token group created by the auction provider 2210 are invalidated and deleted, as shown at step 2222.

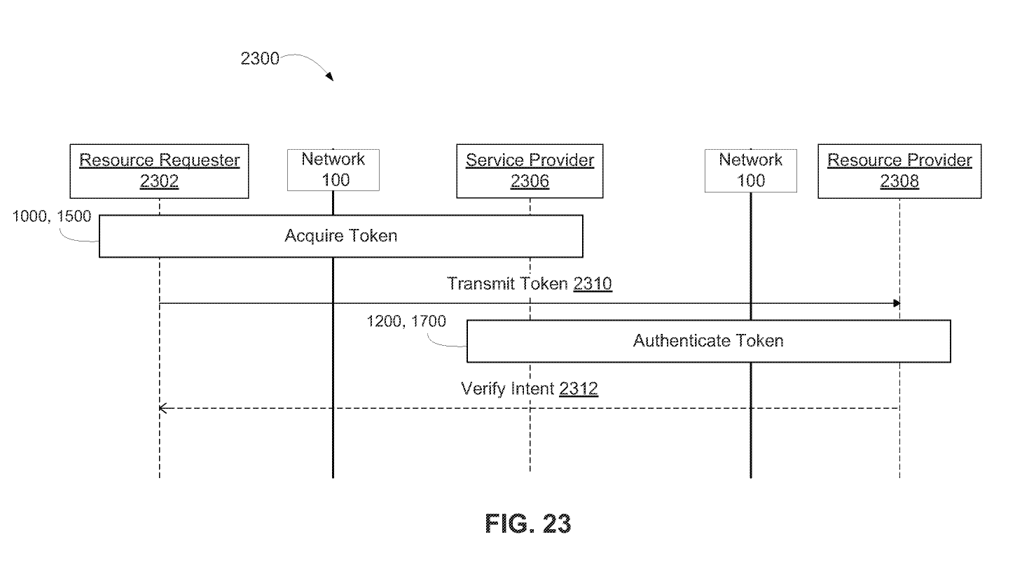

FIG. 23 illustrates an embodiment of a system and method for conveying intent between a resource requester and a resource provider. In this system 2300, a service provider 2306, a first communications network 100, a second communications network 110, a resource provider 2308 and a resource requester 2302 are provided. The process commences with the resource requester 2302 acquiring a token using the process illustrated in either FIG. 10 or FIG. 15 depending on whether the acquisition occurs over a public or secure computer communications connection, and on whether the acquisition is performed using an API 222, 224 or the web portal interface 226. Once the token is received, the resource requester 2302 transmits the received token over the second communication network 110, as shown at step 2310, to the resource provider 2308. The user-defined value of the token will be evidence of the specific intent of the resource requester. This value is also an indirect indicator of the priority placed on receiving access to the resource as determined by the resource requester 2302. The resource provider 2308 performs an authentication of the token to confirm its validity using the process set forth in either FIG. 12 or FIG. 17. In addition, the resource provider 2308 may be a programmatic user seeking to authenticate a token using a custom application with an API key that is compatible with the API 222, 224 used by the service provider 2306 that maintains and executes the token management system 300. If the token is authenticated then a message is transmitted from the resource provider 2308 to the resource requester 2302 over the second communication network 110 confirming the verification of its expression of intent, as shown at step 2312.

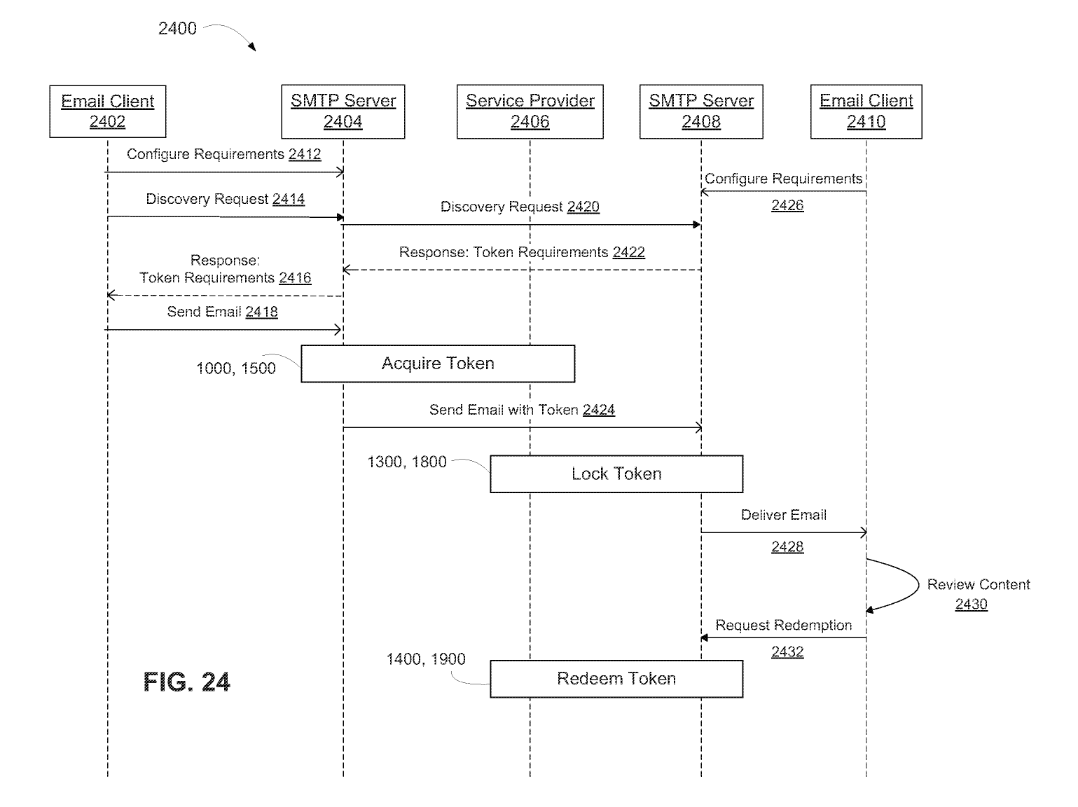

FIG. 24 is an illustration of a system and method for reducing email spam based on a client-server model in an embodiment. In this system 2400, a service provider 2406, a first Simple Mail Transfer Protocol server (“SMTP Server”) 2404, a second SMTP Server (2408), a first email client 2402 and a second email client 2410 are provided. Communications between the first SMTP Server 2404 and the second SMTP Server 2408 occur over a first communications network, while communications between the first SMTP Server 2404 and the second SMTP Server 2408 and between email clients 2402, 2410 and SMTP Servers 2404, 2408 occur over a second communications network. In operation, the first email client 2402 submits a message with its configuration requirements, as shown at step 2412, to the first SMTP Server 2404. Likewise, the second email client 2410 submits its configuration requirements, as shown at step 2426, to the second SMTP Server 2408. The first email client 2402 also submits a discovery request message, as shown at step 2414, to the first SMTP Server 2404 which is subsequently relayed to the second SMTP Server 2408 in a separate electronic message transmission from the first SMTP Server 2404, as shown at step 2420. The discovery request 2420 is transferred through service provider 2406 on one or more of the computer servers 104a, 104n included on the service network 102 controlled and maintained by the service provider 2406. In response to the discovery request message 2420, the second SMTP Server 2408 sends a message with its token requirements, as shown at step 2422. This message is transmitted to the first SMTP Server 2404 and this server in turn transmits a response message with the token requirements, as shown at step 2416, to the first email client 2402. Once received, the first email client 2402 transmits the informational content from a user in an email message, as shown at step 2418, to the first SMTP Server 2404.

In order to facilitate the transfer of the email message to the second email client 2410, the first SMTP Server 2404 executes acquires a transaction token from the service provider 2406 using the process illustrated in either FIG. 10 or FIG. 15, depending on whether the communication occurs over a public or secure connection, or on the web portal interface 226 or an API 222, 224. The first SMTP Server 2404 subsequently sends the email message received from the first email client 2404 to the second SMTP Server 2408, as shown at step 2424. The email message, however, is transmitted with the acquired token as either an attachment or an integrated element in the content of the message. After receipt of the email with the accompanying token, the second SMTP Server 2408 performs a process to lock the token and its associated value using the process illustrated in either FIG. 13 or FIG. 18. Once locked, the second SMTP Server 2408 delivers the email message, as shown at step 2428, to the second e-mail client 2410. The e-mail message recipient reviews the content of the e-mail message, as shown at step 2430, and elects to redeem the token value, as shown at step 2432, if the content of the e-mail message does not satisfy one or more criterion established by the e-mail recipient. In this case, the second SMTP Server 2408 initiates the process to redeem the token value, which process is illustrated in either FIG. 14 or FIG. 19 depending on whether the communication occurs over a public or secure computer communications connection, or on the web portal interface 226 or an API 222, 224. As a result, in requiring all e-mail senders to send tokens with e-mail message communications, e-mail recipients now have the option and the opportunity to be compensated for the receipt of e-mail messages having little to no informational content according to the subjective criterion established by the e-mail recipients.

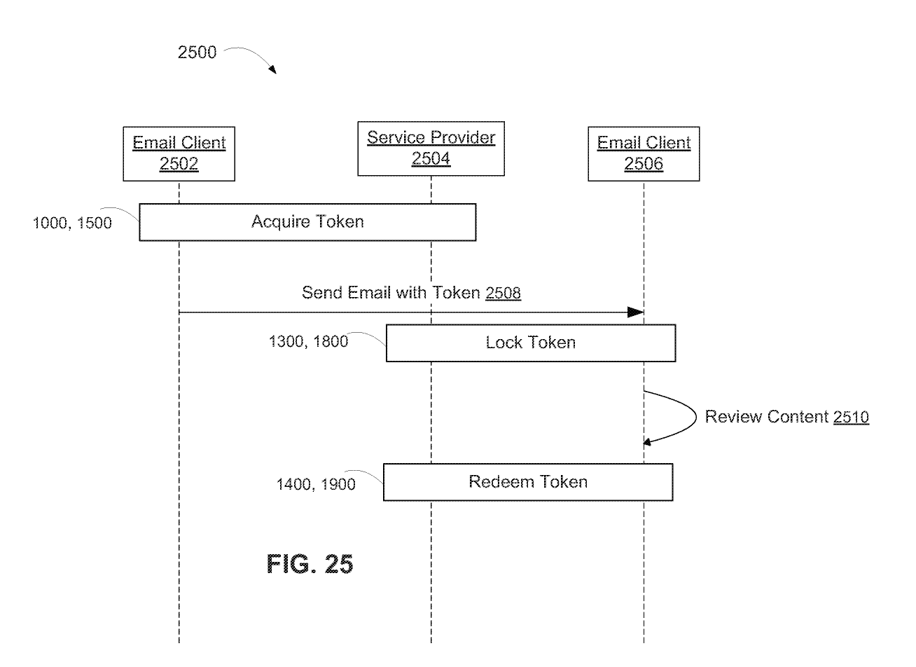

FIG. 25 illustrates a system and method for reducing e-mail spam using a client based model in an embodiment. In this system 2500, a first e-mail client 2502, a service provider 2504 and a second e-mail client 2506 are provided. Communications between each email client 2502, 2506 and the service provider 2504 occur over a first communications network, while communications between the email clients 2502, 2506 occur over a second communications network. The first e-mail client 2502 acquires a token from the service provider 2504 using a process illustrated in either FIG. 10 or FIG. 15 for token acquisition. The first e-mail client 2502 generates and sends an e-mail communication with the acquired token, as shown as step 2508, to the second e-mail client 2506. The second e-mail client 2506 then proceeds to lock the token and its associated value using the process illustrated in either FIG. 13 or FIG. 18. The recipient of the e-mail message received on the second e-mail client 2506 reviews the content, as shown at step 2510, and elects to redeem the user-defined value of the received token if the informational content of the e-mail message has little to no value according to one or more criterion established by the e-mail recipient using the second e-mail client 2506. The token value is redeemed using the process illustrated in either FIG. 14 or FIG. 19 depending on whether the second email client 2506 communicated occurs over a public or secure communication connection with the web portal interface 226 or an API 222, 224 operating on the service network 102 operated by the service provider 2504.

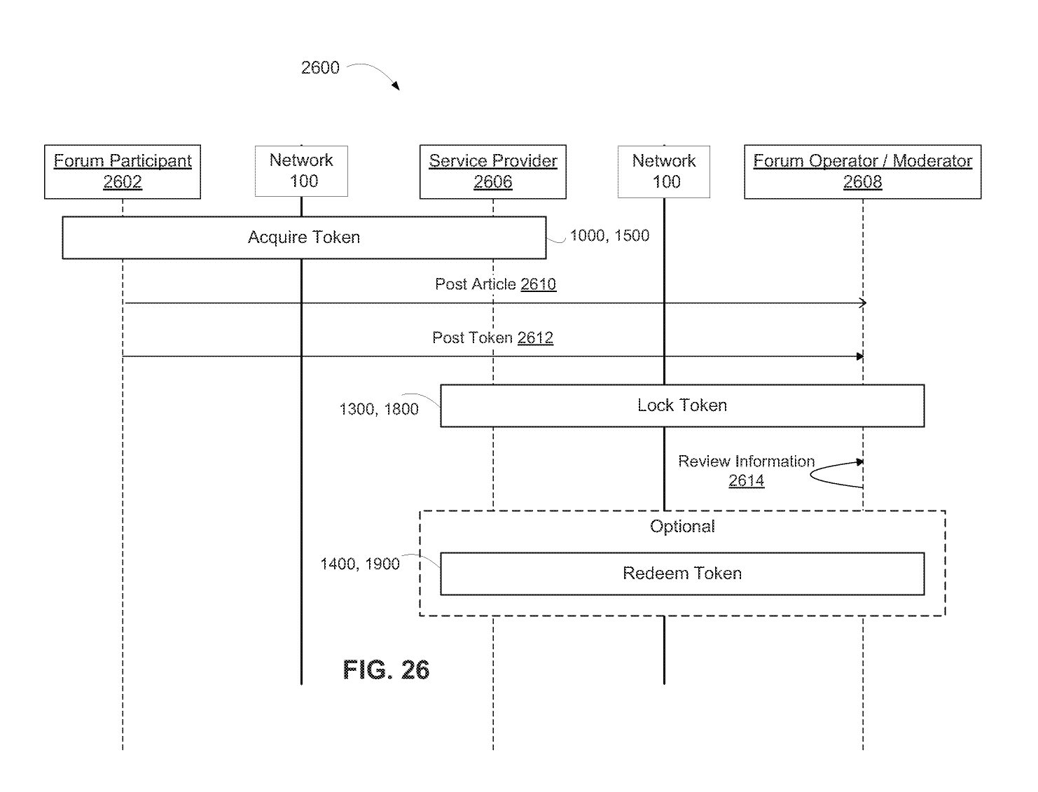

FIG. 26 illustrates a system and method for reducing forum and comment Spam online. In this system 2600, a first forum participant 2602, a first communications network 100, a second communications network 110, a service provider 2606, and a forum operator/moderator 2608 are provided. In this scenario, the forum participant 2602 communicates with the service provider 2606 over a public or secure communications connection using a process illustrated in either FIG. 10 or FIG. 15 to acquire a token. Once the token is acquired, the forum participant 2602 subsequently generates and posts an article in an online forum, an online weblog or other online community of users over the second communications network 110, as shown in step 2610. In addition to posting an article, the forum participant 2602 also posts the acquired token over the second communication network 110, as shown in step 2612, in the forum directly with the forum operator/moderator 2608. The forum operator/moderator 2608 locks the token value upon receipt of the posted token using the process illustrated in either FIG. 13 or FIG. 18 depending on whether the communication between the forum operator/moderator 2608 and the service provider 2606 is performed over a public or secure communication connection using either the web portal interface 226 or an API 222, 224. The forum operator/moderator 2608 then proceeds to review the content of the posted article, as shown at step 2614, and optionally elects to redeem the token value if the content of the article is deemed to have little to no value based on its own criteria, or according to feedback received from participants in the online forum, weblog or online community. In concluding that the posted article has little to no value, the forum operator/moderator 2608 performs the token redemption process illustrated in FIG. 14 or FIG. 19 to redeem the value associated with the token received from the forum participant 2602.

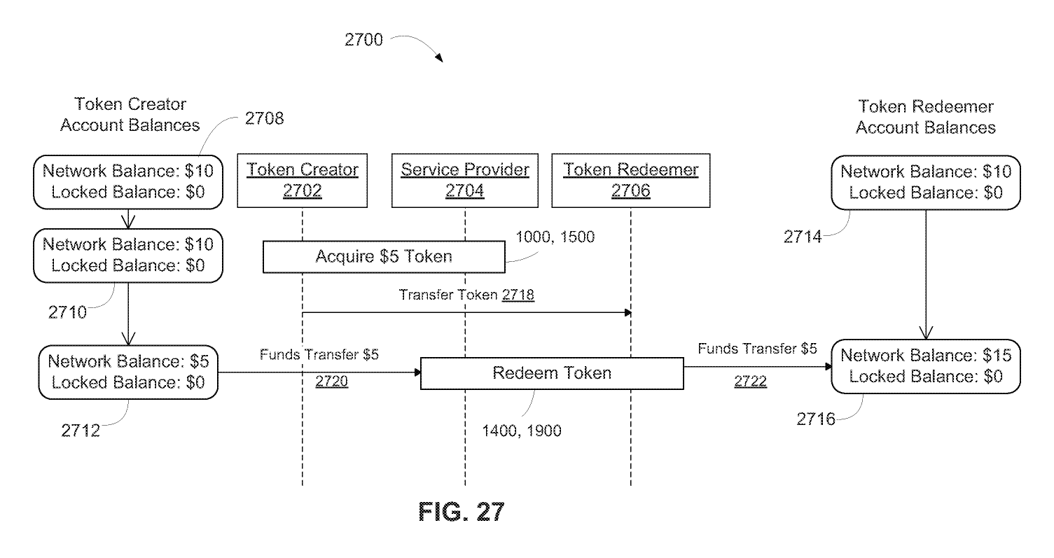

FIG. 27 illustrates a process and system for token creation, redemption and the flow of token value without requiring the token locking in an embodiment. In this system 2700, a token creator 2702, a service provider 2704 and a token redeemer 2706 are provided. The token creator 2702 initially creates a token on the token management system 300 and subsequently acquires a replicated copy of the token using the process illustrated in either FIG. 10 or FIG. 15. In this representative example, the user-defined value of the token created by token creator 2702 is $5.00. Initially, the token creator has existing account balances in the token management system 300. As shown here, the initial account balances shown in block 2708 indicate a network balance of $10.00 and a locked balance of $0.00. The token creator 2702 transfers the token to token redeemer 2706, as shown at step 2718. At this point, a token transfer is performed from the token creator 2702 to the token redeemer 2706; however, the network balance remains at $10.00 and the locked balance remains at $0.00, as shown in block 2710. The token redeemer 2706 receives the transferred token and elects to redeem the token value using a process illustrated in either FIG. 14 or 19 which results in a transfer of the token value in the amount of $5.00 from the network account of the token creator 2702 to the network account of the token redeemer 2706. In this case, the network balance for the token creator 2702 reduces from $10.00 to $5.00 and the locked balance remains at $0.00, as shown in block 2712. The funds transfer is illustrated at step 2720 and results in a transfer of funds from an interim holding account maintained on servers 104a, 104n operated by the service provider 2704 to the network account of the token redeemer 2706, as shown at step 2722. The initial account balances of the token redeemer are illustrated in block 2714. In this case, the initial network balance of the token redeemer 2706 is $10.00 and the locked balance is $0.00. After the funds transfer, the network balance of the token redeemer 2706 is increased to $15.00 and the locked balance remains at $0.00, as shown in block 2716.

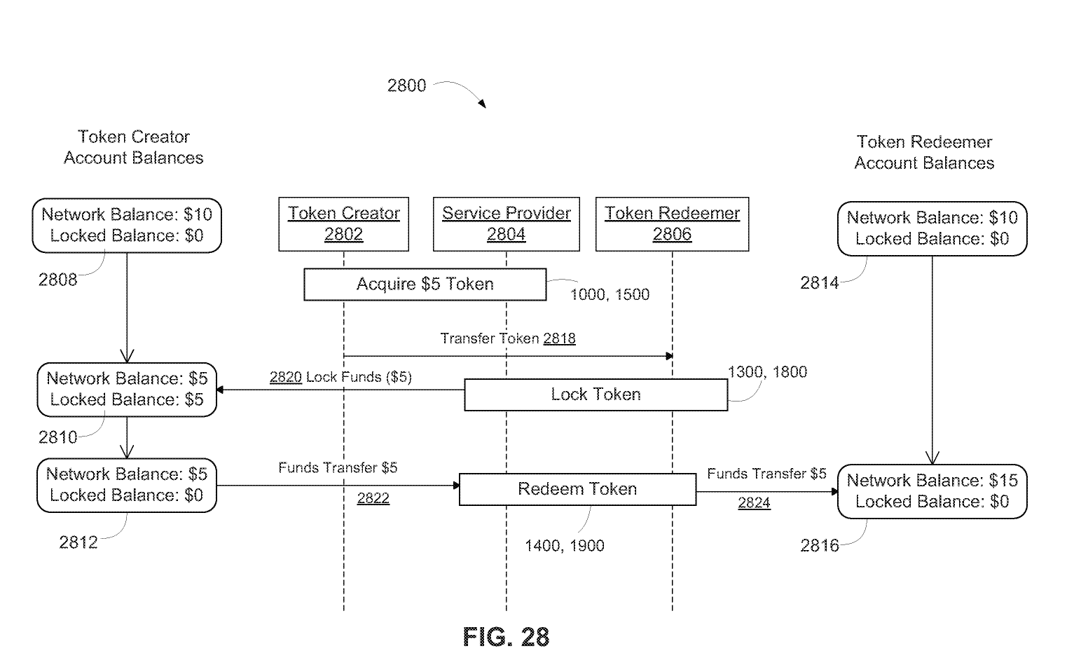

FIG. 28 illustrates a system and method for token creation, redemption and the flow of funds with token locking in an embodiment. In this system 2800, a token creator 2802, a service provider 2804 and a token redeemer 2806 are provided. Initially, the token creator's account balances show a network balance of $10.00 and a locked balance of $0.00, as shown in block 2808. The token redeemer's 2806 initial account balances are shown as having a network balance of $10.00 and a locked balance of $0.00, as shown in block 2814. The token creator 2802 acquires a token from the service provider 2804 and the user-defined value of the token acquired is $5.00 using the process for acquiring token illustrated in FIG. 10 or 15 depending on whether the acquisition occurs over a public or secure communications connection using either a web portal interface 226 or an API 222, 224. Once acquired, the token creator 2802 transfers the token 2818 to the token redeemer 2806. In this embodiment, however, the token redeemer 2806 elects to lock the token before redeeming funds using a process illustrated in either FIG. 13 or 18. The network balance of the token creator reduces $5.00 and the locked balance increases to $5.00, as shown in block 2810. Thus, the locking process has the effect of moving funds from the account balance of a user to an interim holding account maintained on servers 104a, 104n operated by the service provider 2804 in the token management system 300, as shown in step 2820. Later, the token redeemer 2806 elects to redeem the token value and uses the process illustrated in either FIG. 14 or 19 depending on whether the communication occurs over a public or secure communication connection. The execution of the redemption process by the token redeemer 2806 results in a transfer of funds from the interim holding account on the token management system 300 to the network balance account of the token redeemer 2806, as shown in block 2816. The funds transfer results in a reduction of the locked balance for the token creator 2802, as shown in block 2812, at the time of a funds transfer (step 2822) and the subsequent transfer of funds (step 2824) to the token redeemer 2806 results in the increase in the network account balance for the token redeemer 2806 to a total network balance of $15.00.

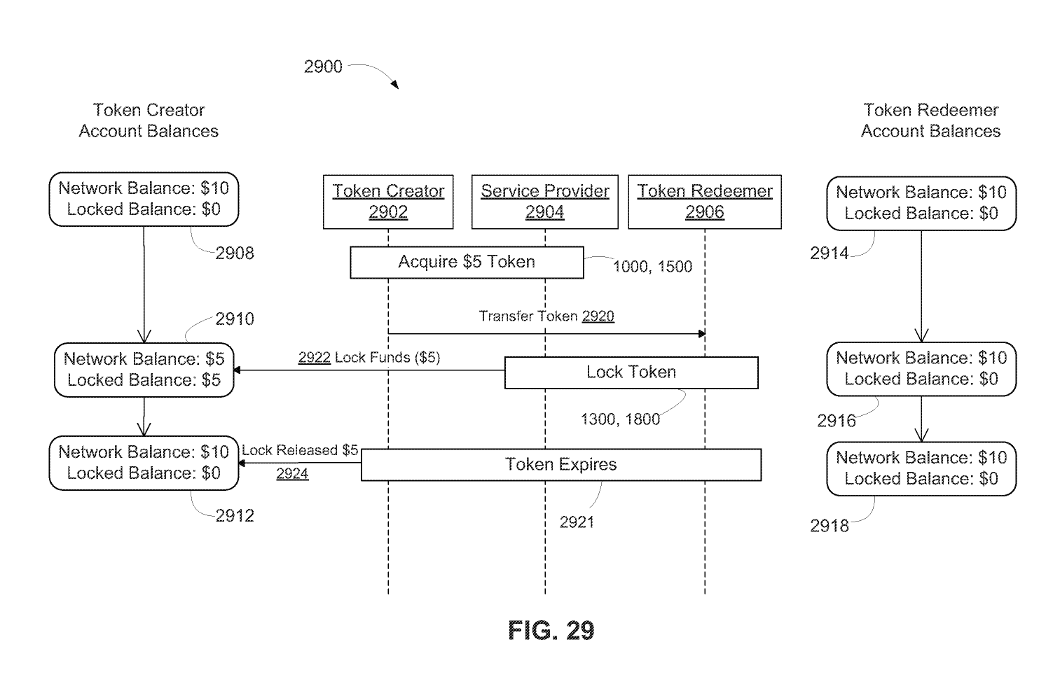

FIG. 29 illustrates a system and method involving token expiration and the flow of funds in an embodiment. In this system 2900, a token creator 2902, a service provider 2904 and a token redeemer 2906 are provided. The initial account balances of the token creator 2902 are shown on the left hand side in block 2908 and the initial account balances of the token redeemer 2906 are shown in the right hand side in block 2914. In block 2908, the initial balances of the token creator 2902 reflect a network balance of $10.00 and a locked balance of $0.00. The token creator 2902 creates and acquires a token having a $5.00 value using the process illustrated in either FIG. 10 or 15 depending on whether a public or secure communication connection is used, and on whether the token acquisition request was made a web portal interface 226 or an API 222, 224. After acquiring the token, the token creator 2902 transfers the token to the token redeemer 2906, as shown at step 2920. The token redeemer 2906 locks the token using the process illustrated in FIG. 13 or 18, which results in a transfer of $5.00 from the network balance account of the token creator 2902 to an interim holding account maintained on the servers 104a, 104n controlled by the service provider 2904. The locking of funds is shown at step 2922 and the network balance and the locked balance for the token creator 2902 are shown in block 2910. At this point, the account balances of the token redeemer 2906 remain the same, as illustrated in block 2916, and show a network balance of $10.00 and a locked balance of $0.00. If token redeemer 2906 elects to allow the token to expire, as shown at step 2921, then the lock is released, as shown at step 2924, and the network balance of the token creator 2902 is increased from $5.00 back to its original $10.00 balance, as shown in block 2912. Thus, the expiration of the time for redemption of a token results in the automatic return of funds to the token creator's network balance account in the token management system 300. Once the time for redemption expires, at no time, will funds held in an interim holding account on the token management system 300 be transferred to the account of the token redeemer 2906, as is reflected in block 2918.

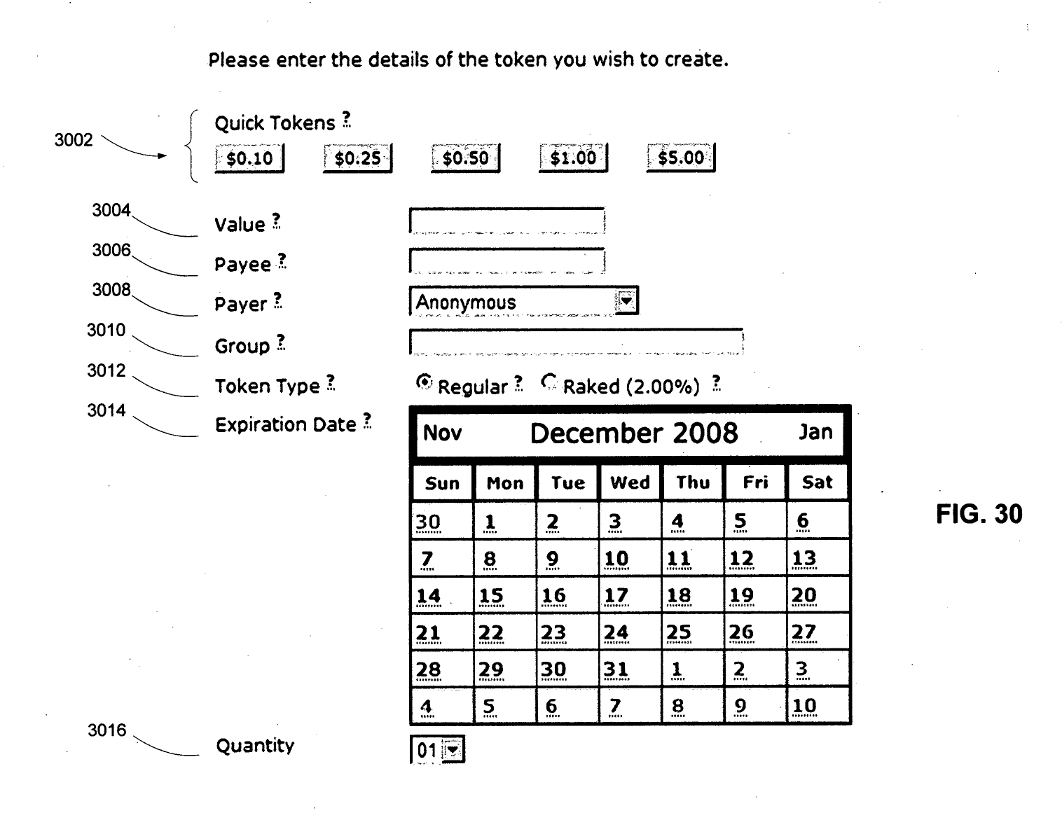

FIG. 30 is an illustration of a user interface accessible from the web partial interface 226 for the creation of a new token. As shown here, several buttons 3002 are displayed for the creation of a user-defined value for a new token. A user may elect to establish a token value from the “Quick Token” button options displayed or set an entirely different value for a user-defined value. Data can also be entered in several additional fields, including a token value field 3004, a token payee identification field 3006, a token payer identification field 3008, a token group identification field 3010 and two buttons permitting the election of a token type 3012 as either a “regular” type or “raked” type. In addition, a calendar is displayed which allows the token creator to set a token expiration date 3014 for a new token. A counter 3016 is provided to allow a user to specify the number of tokens to be created with the designated information.

As indicated above, the token type 3012 button options permit a user to create either a regular token or a raked token. In this embodiment, a transfer-fee of 2% of the value established for the token is shown. A “raked” token is a token which permits the token redeemer to immediately withdraw funds out of the token management system 300 at the time the token is redeemed. The account balance of the token creator will be debited the user-defined value of the token plus the transfer-fee of 2%. This transfer-fee is transferred to a token-transaction-redemption account in the token management system 300. On the other hand, a “regular” token is available for redemption only within the service network 102 executing the token management system 300. The user-defined value of regular tokens remains within the service network 102 and only at the time funds are to be withdrawn out of the network will a transfer-fee be withdrawn from the account balance of a token redeemer. This transfer-fee will be transferred to a token-transaction-redemption account in the token management system 300. Since token creators establish the user-defined values for tokens for voluntary redemption by token redeemers, they voluntarily establish the value as an upper limit on the amount that can be redeemed. On the other hand, a token redeemer can elect to redeem a user-specified value that is less than the user-defined value established by the token creator. Thus, in the case of an information insurance scenario, if the informational content of a message is considered to be particularly valuable, the token redeemer may elect to allow an accompanying token to expire or to redeem the token for a user-specified value that is less the full amount of the user-defined value of the token.

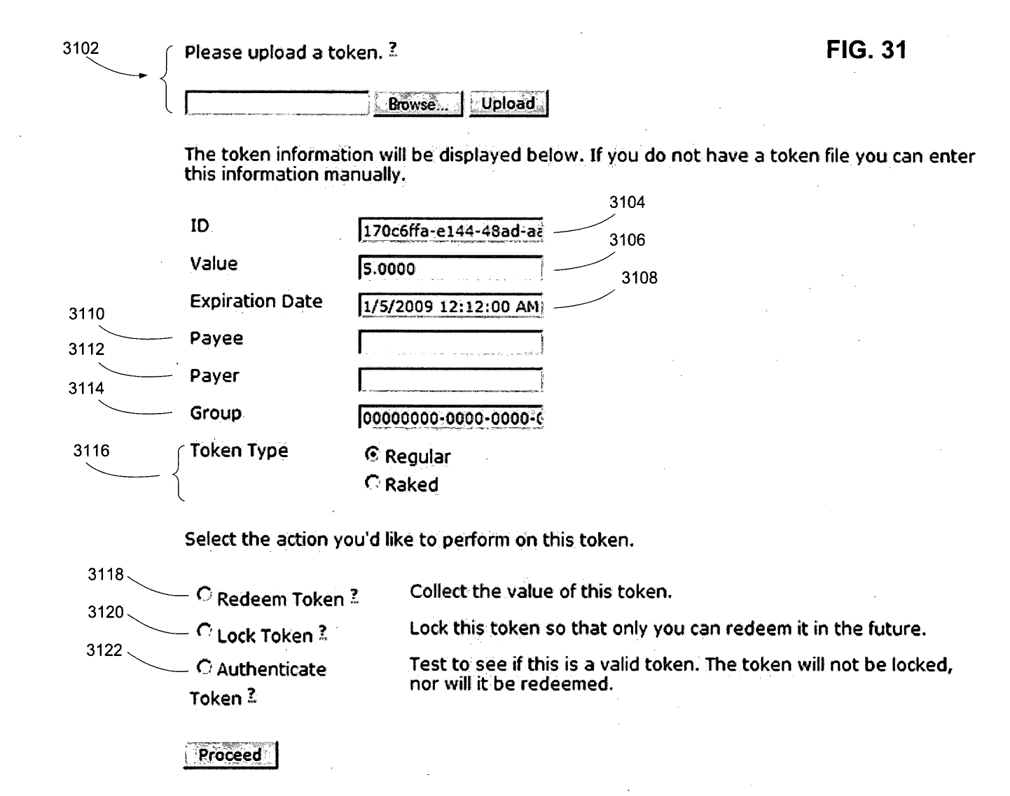

FIG. 31 is an illustration of a user interface for the uploading, authentication, locking and redemption of tokens. Data field 3102 allows a user to browse the contents of a receiving device 108a, 108b, 108c using the “Browse . . . ” button to locate a token and to then upload the token using the upload button. The data included in the token that is uploaded will be extracted and displayed in the fields shown on this screen. In the “Identification” data field 3104 the token identification is displayed. In the “Value” data field 3106, the user-defined value of the token is displayed, which in this example is $5.00. In the “Expiration Date” data field 3108, the expiration date of the token is shown. In the “Payee” data field 3110, an alias for a token payee is displayed, if provided by the token creator. In this example, no token payee is specified and any recipient would be able to lock and redeem the user-defined value of this token. In the “Payer” data field 3112, a token payer alias is provided. Here, no token payer identification has been specified by the token creator and therefore any payer could lock and redeem the user-defined value of this token. In the “Group” data field 3114, a token group identification is provided which indicates that this token is included in a pre-defined token group. All tokens in the token group have the same token group identification. The “Token Type” tag 3116 indicates the type of token which has been uploaded, which in this case is a “regular” token. This user interface also enables a user to specify the type of action that is to be performed on the token. As indicated on this user interface, the three options available enable a user to “Redeem Token” 3118, to “Lock Token” 3120 or to “Authenticate Token” 3122. The “Redeem Token” 3118 option enables the token redeemer to collect the user-defined value of the token or a lesser user-specified value. The “Lock Token” 3120 option enables a user to lock the uploaded token to prevent any other party from locking or redeeming the token. The “Authenticate Token” 3122 option enables a user authenticate the token to confirm its validity as an active token in the token management system 300. The authentication process does not lock the token and does not redeem the value but compares the contents of the data fields of the token to data stored in one or more token databases 218a, 218b to confirm the validity of the token.

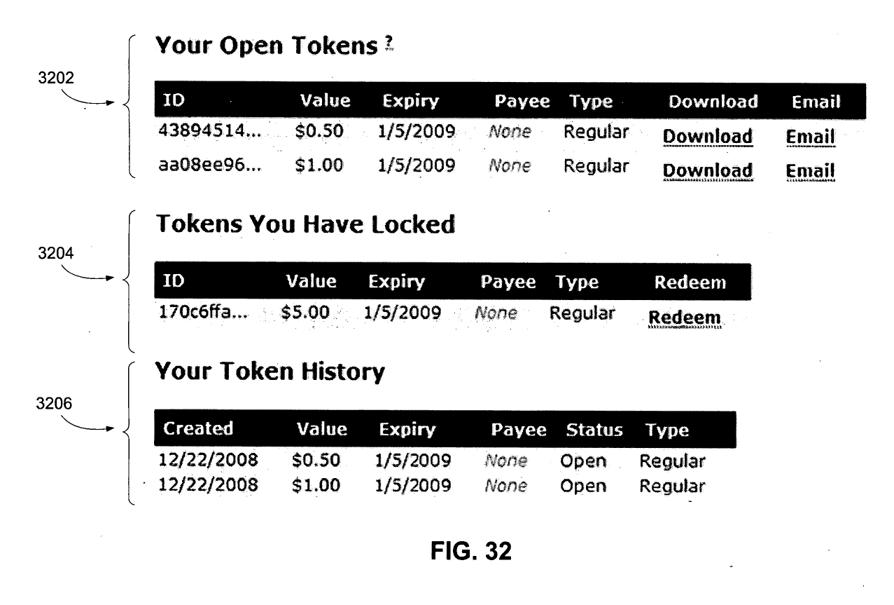

FIG. 32 is an illustration of a user interface which displays the data included in the token data table. In this embodiment of the user interface, the status of each token associated with a registered user is shown in different sections. The first section 3202 lists current open tokens for a registered user and also specifies the token identification, the token value, the token expiration date, the token payee (if any), the token type, a link for downloading the token and a link for having the token transferred by email to the token creator or any other designated recipient.

The second section 3204 lists locked tokens associated with a registered user and the status of each locked token. More specifically, in this embodiment, this second section 3204 lists token identifications for each locked token, the token value, the token expiration date, the token payee (if any), the token type (i.e., regular or raked), and a link to enable a registered user to redeem either the user-defined value or a user-specified value which is less than the user-defined value set by a token creator.

The third section 3206 displays the token history for each of the registered user's associated tokens. This section identifies the token creation date, the token value, the token expiration date, token payee (if any), the token status, and the token type. In one embodiment the status of a token is deemed to be “Active” if the token has not been locked or redeemed. In an alternative embodiment, as shown here, the token status “Open” indicates that the token has neither been “Locked” nor “Redeemed.”

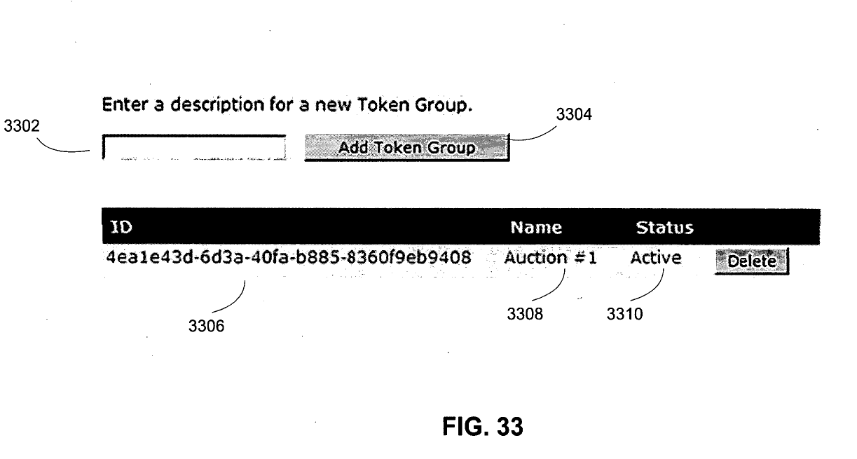

FIG. 33 is an illustration of a user interface for describing a new token group. A new token group description is entered into field 3302 and button 3304 is used to add the new token group with the user specified description to the list of active token groups for a registered user. A section is also included which lists active token groups for the registered user. This section lists token group identifications 3306, token group names 3308 and the status of each token group 3310. A “delete” button is also provided in an embodiment to enable a user to delete select token groups. In this example, the token group name “Auction #1” is included in the token group name field 3308 and a token status of “Active” is included in the token status field 3310. A computer-generated alphanumeric code is included in the token group identification field 3306.

Although specific embodiments have been illustrated and described herein, it will be appreciated by those of ordinary skill in the art that a wide variety of alternate and/or equivalent implementations may be substituted for the specific embodiments shown and described without departing from the scope of the present invention. This application is intended to cover any adaptations or variations of the embodiments discussed herein.

What I claim is:

1. A method for using tokens in a transaction handling system, the method comprising:
receiving at least one token transmitted from a sending device, the at least one token having a user-defined value and a plurality of data fields;
locking the at least one transmitted token from a receiving device; and
redeeming from the receiving device the user-defined value of the locked at least one transmitted token.

2. The method of claim 1 wherein the plurality of data fields includes a token identification field, a token expiration date field, a token value field, a token type field and a token group identification field.

3. The method of claim 2 wherein the token group identification field includes a token group identifier.

4. The method of claim 3 wherein the redeeming of the user-defined value of one token including the token group identifier comprises invalidating all other tokens including the token group identifier.

5. The method of claim 2 wherein the plurality of fields further includes a token payer field and a token payee field.

6. The method of claim 2 wherein the token type field includes a token type designation, the token type designation comprising one of a token regular type and a token raked type.

7. The method of claim 1 further comprising authenticating the at least one transmitted token, the locking of the at least one transmitted token performed after the at least one transmitted token is authenticated.

8. The method of claim 7 wherein the at least one transmitted token is authenticated from a verification of each datum included in each of the plurality of data fields with data stored in the transaction handling system.

9. The method of claim 6 wherein the locking of the at least one transmitted token comprises:
comparing a token payee field in the at least one transmitted token to at least one alias of a recipient of the at least one token, the recipient being a registered user having a user account on at least one server in the transaction handling system; and
transferring the user-defined value for the at least one transmitted token from a user account on the at least one server for a token creator to an interim holding account on the at least one server if the at least one transmitted token is authenticated and the token type designation of the at least one transmitted token is the token regular type.

10. The method of claim 6 wherein the locking of the at least one transmitted token comprises:
comparing a token payee field in the at least one transmitted token to at least one alias of a recipient of the at least one token, the recipient being a registered user having a user account on at least one server in the transaction handling system; and
transferring the user-defined value for the at least one transmitted token and a transfer-fee from a user account on the at least one server for a token creator to an interim holding account on the at least one server if the at least one transmitted token is authenticated and the token type designation of the at least one transmitted token is the token raked type.

11. The method of claim 1 wherein the at least one token transmitted from the sending device is received as a clear-text attachment to an electronic mail message.

12. The method of claim 1 wherein the at least one token received is transmitted from the sending device in clear-text.

13. The method of claim 1 wherein the at least one token received is transmitted from the sending device in encrypted text.

14. The method of claim 1 wherein the redeeming of the user-defined value comprises transferring the user-defined value for the at least one token from an interim holding account to a user account on at least one server of the transaction handling system for a recipient of the at least one token, the recipient being a registered user of the transaction handling system.

15. The method of claim 8 wherein the redeeming of the user-defined value of the locked at least one transmitted token is performed if an informational content of the electronic mail message does not satisfy a recipient-determined criterion.

16. The method of claim 15 wherein an individual reviewer of the informational content establishes the recipient-determined criterion.

17. The method of claim 15 wherein a plurality of reviewers of the informational content establish the recipient-determined criterion.

18. The method of claim 17 wherein the plurality of reviewers are members of at least one of an online forum, an online weblog and an online community of users.

19. The method of claim 8 further comprising releasing the locking of the at least one token after an expiration date specified in a token expiration date field included in the plurality of data fields of the at least one token if an informational content of the electronic message does satisfy a recipient-determined criterion.

20. The method of claim 19 wherein the releasing of the locking of the at least one token comprises transferring the user-defined value for the at least one token from an interim holding account on the at least one server to a user account for a first registered user, the first registered user having created the at least one token.

21. The method of claim 1 wherein a first registered user provides the user-defined value for voluntary redemption by a recipient of the at least one token.

22. The method of claim 15 wherein a priority of the informational content is determined from the user-defined value of the at least one token.

23. The method of claim 15 wherein the recipient-determined criterion is based on a relevance-ranking of the informational content to an informational need of at least one recipient.

24. The method of claim 3 wherein the locking of the at least one transmitted token comprises locking at least one transmitted token including the token group identifier.

25. The method of claim 24 wherein the redeeming of the user-defined value of the locked at least one token comprises redeeming the user-defined value of at least one token including the token group identifier.

26. The method of claim 5 wherein a first registered user is specified in the token payer field.

27. The method of claim 5 wherein a second registered user is specified in the token payee field.

28. The method of claim 6 wherein the redeeming of the user-defined value of the locked at least one token comprises transferring the user-defined value from an interim holding account to a user account for a registered user on at least one server in the transaction handling system when the token designation type is a token regular type.

29. The method of claim 6 wherein the redeeming of the user-defined value of the locked at least one token comprises transferring a user-specified value from an interim holding account to a user account of a registered user on at least one server in the transaction handling system when the token designation type is a token regular type, the user-specified value being less than the user-defined value, the registered user specifying the user-specified value.

30. The method of claim 6 wherein the redeeming of the user-defined value of the locked at least one token comprises:
transferring the user-defined value from an interim holding account to a user account for a registered user on at least one server in the transaction handling system when the token designation type is a token raked type, the registered user being a token redeemer; and
transferring a transfer-fee from the interim holding account to a token-transaction-redemption account on the at least one server in the transaction handling system, the transfer-fee being less than the user-defined value.

31. The method of claim 6 wherein the redeeming of the user-defined value of the locked at least one token comprises:
transferring a user-specified value from an interim holding account to a user account of a registered user on at least one server in the transaction handling system when the token designation type is a token raked type, the user-specified value being less than the user-defined value, the registered user specifying the user-specified value, the registered user being a token redeemer; and
transferring a transfer-fee from the interim holding account to a token-transaction-redemption account on the at least one server in the transaction handling system, the transfer-fee being less than the user-defined value.

32. The method of claim 1 wherein the sending device is one of a group comprising a desktop computer, a laptop computer, a personal digital assistant, an Internet-enabled telephone and a mobile telephone.

33. The method of claim 1 wherein the receiving device is one of a group comprising a desktop computer, a laptop computer, a personal digital assistance, a mobile telephone, an Internet-enabled telephone, a vending machine, a laundry washing machine and a laundry drying machine.

34. An apparatus for using tokens in a transaction handling system, the apparatus comprising:
a memory;
a processor communicatively coupled to the memory, the processor operative to:
receive at least one token transmitted from a sending device, the at least one token having a user-defined value and a plurality of data fields;
lock the at least one transmitted token; and
redeem the user-defined value of the locked at least one transmitted token.

35. The apparatus of claim 34 wherein the plurality of data fields includes a token identification field, a token expiration date field, a token value field, a token type field and a token group identification field.

36. The apparatus of claim 34 wherein the token group identification field in the at least one transmitted token includes a token group identifier.

37. The apparatus of claim 36 wherein the user-defined value of one token including the token group identifier is redeemed and all other tokens including the token group identifier are invalidated when the user-defined value of the one token is redeemed.

38. The apparatus of claim 35 wherein the plurality of fields further includes a token payer field and a token payee field.

39. The apparatus of claim 35 wherein the token type field includes a token type designation, the token type designation comprising one of a token regular type and a token raked type.

40. The apparatus of claim 34 wherein the at least one transmitted token is authenticated before the at least one transmitted token is locked.

41. The apparatus of claim 40 wherein the at least one transmitted token is authenticated from a verification of each datum included in each of the plurality of data fields with data stored in the transaction handling system.

42. The apparatus of claim 40 wherein the at least one transmitted token is locked when:
a token payee field in the at least one transmitted token is compared to at least one alias of a recipient of the at least one transmitted token, the recipient being a registered user having a user account on the transaction handling system; and
the user-defined value for the at least one transmitted token is transferred to an interim holding account on at least one server in the transaction handling system if the at least one transmitted token is authenticated.

43. The apparatus of claim 34 wherein the at least one token transmitted from the sending device is received as a clear-text attachment to an electronic mail message.

44. The apparatus of claim 34 wherein the at least one token received is transmitted from the sending device in clear-text.

45. The apparatus of claim 34 wherein the at least one token received is transmitted from the sending device in encrypted text.

46. The apparatus of claim 34 wherein the user-defined value is redeemed when the user-defined value for the at least one token is transferred from an interim holding account to a user account on the transaction handling system for a recipient of the at least one token, the recipient being a registered user of the transaction handling system.

47. The apparatus of claim 43 wherein the user-defined value of the locked at least one transmitted token is redeemed if an informational content of the electronic mail message does not satisfy a recipient-determined criterion.

48. The apparatus of claim 47 wherein an individual reviewer of the informational content establishes the recipient-determined criterion.

49. The apparatus of claim 47 wherein a plurality of reviewers of the informational content establish the recipient-determined criterion.

50. The apparatus of claim 49 wherein the plurality of reviewers are members of at least one of an online forum, an online weblog and an online community of users.

51. The apparatus of claim 43 wherein the lock of the at least one token is released after an expiration date specified in a token expiration date field included in the plurality of data fields of the at least one token if an informational content of the electronic message does satisfy a recipient-determined criterion.

52. The apparatus of claim 51 wherein the lock of the at least one token is released when the user-defined value for the at least one token is transferred from an interim holding account on the at least one server to a user account for a first registered user, the first registered user having created the at least one token.

53. The apparatus of claim 34 wherein a first registered user provides the user-defined value for voluntary redemption by a recipient of the at least one token.

54. The method of claim 47 wherein a priority of the informational content is determined from the user-defined value of the at least one token.

55. The apparatus of claim 47 wherein the recipient-determined criterion is based on a relevance-ranking of the informational content to an informational need of at least one recipient.

56. The apparatus of claim 38 wherein a first registered user is specified in the token payer field.

57. The apparatus of claim 38 wherein a second registered user is specified in the token payee field.

58. The apparatus of claim 39 wherein the redeemed user-defined value of the locked at least one token is transferred from an interim holding account to a user account for a registered user on at least one server in the transaction handling system when the token designation type is a token regular type.

59. The apparatus of claim 39 wherein the redeemed user-defined value is a user-specified value, the user-specified value transferred from an interim holding account to a user account of a registered user on at least one server in the transaction handling system when the token designation type is a token regular type, the user-specified value being less than the user-defined value, the registered user specifying the user-specified value.

60. The apparatus of claim 39 wherein the user-defined value is redeemed when the processor directs the transaction handling system to:
transfer the user-defined value from an interim holding account to a user account for a registered user on at least one server in the transaction handling system when the token designation type is a token raked type, the registered user being a token redeemer; and
transfer a transfer-fee from the interim holding account to a token-transaction-redemption account on the at least one server in the transaction handling system, the transfer-fee being less than the user-defined value.

61. The apparatus of claim 39 wherein the user-defined value is redeemed when the processor directs the transaction handling system to:
transfer a user-specified value from an interim holding account to a user account of a registered user on at least one server in the transaction handling system when the token designation type is a token raked type, the user-specified value being less than the user-defined value, the registered user specifying the user-specified value, the registered user being a token redeemer; and
transfer a transfer-fee from the interim holding account to a token-transaction-redemption account on at least one server in the transaction handling system, the transfer-fee being less than the user-defined value.

62. A system for receiving and using tokens in transactions performed over a network, the system comprising:
at least one information receiving device, the at least one information receiving device operative to:
receive at least one token, the received at least one token transmitted with at least one electronic message from at least one information sending device, the at least one token having a user-defined value and a plurality of data fields;
request a lock of the at least one token over a first communication network received with each of the at least one electronic message; and
request redemption of the user-defined value of the at least one locked token;
a second communication network between the at least one information receiving device and the at least one information sending device; and
a token management subsystem comprised of at least one server, the token management subsystem having a plurality of interfaces for communication over the first communication network with the at least one information sending device and the at least one information receiving device.

63. The system of claim 62 wherein the network is the Internet.

64. The system of claim 62 wherein the first communication network is the Internet.

65. The system of claim 62 wherein the second communication network is at least one of a wireless communication network and a computer data communication network.

66. The system of claim 62 wherein the plurality of interfaces includes a public application programming interface, a secure application programming interface and an Internet web portal interface.

67. The system of claim 66 wherein a secure communication connection is established on the first communication network between the secure application programming interface and the at least one receiving device.

68. The system of claim 67 wherein the secure communication connection is a Secure Sockets Layer connection.

69. The system of claim 62 wherein the plurality of data fields includes a token identification field, a token expiration date field, a token value field, a token type field and a token group identification field.

70. The system of claim 69 wherein the token group identification field includes a token group identifier.

71. The system of claim 69 wherein the redemption of the user-defined value of one token including the token group identifier invalidates all other tokens including the token group identifier.

72. The system of claim 69 wherein the plurality of fields further includes a token payer field and a token payee field.

73. The system of claim 69 wherein the token type field includes a token type designation, the token type designation comprising one of a token regular type and a token raked type.

74. The system of claim 62 wherein the lock of the at least one token is performed after the at least one token is authenticated.

75. The system of claim 74 wherein the at least one token is authenticated from a verification of each datum included in each of the plurality of data fields with data stored in the token management subsystem.

76. The system of claim 74 wherein the at least one token is locked when:
a token payee field in the at least one token is compared to at least one alias of a recipient of the at least one token, the recipient being a registered user having a user account on the at least one server in the token management subsystem; and
the user-defined value for the at least one token is transferred to an interim holding account on the at least one server of the token management subsystem if the at least one token is authenticated.

77. The system of claim 62 wherein the at least one token transmitted from the sending device is received as a clear-text attachment to the at least one electronic mail message.

78. The system of claim 62 wherein the at least one token is received over the second communication network from the sending device in clear-text.

79. The system of claim 62 wherein the at least one token is received over the second communication network from the sending device in encrypted text.

80. The method of claim 62 wherein the user-defined value is redeemed when the user-defined value for the at least one token is transferred from an interim holding account to a user account on at least one server of the token management subsystem for a recipient of the at least one token, the recipient being a registered user of the token management subsystem.

81. The system of claim 77 wherein the user-defined value of the locked at least one token is redeemed if an informational content of the electronic mail message does not satisfy a recipient-determined criterion.

82. The system of claim 81 wherein an individual reviewer of the informational content establishes the recipient-determined criterion.

83. The system of claim 81 wherein a plurality of reviewers of the informational content establish the recipient-determined criterion.

84. The system of claim 83 wherein the plurality of reviewers are members of at least one of an online forum, an online weblog and an online community of users.

85. The system of claim 77 wherein the lock of the at least one token is released after an expiration date specified in a token expiration date field included in the plurality of data fields of the at least one token if an informational content of the electronic message does satisfy a recipient-determined criterion.

86. The system of claim 85 wherein the user-defined value for the at least one token is transferred from an interim holding account on the at least one server to a user account for a first registered user when the lock is released, the first registered user having created the at least one token.

87. The system of claim 62 wherein a first registered user provides the user-defined value voluntarily for redemption by a recipient of the at least one token.

88. The system of claim 81 wherein a priority of the informational content is determined from the user-defined value of the at least one token.

89. The system of claim 81 wherein the recipient-determined criterion is based on a relevance-ranking of the informational content to an informational need of at least one recipient.

90. The system of claim 72 wherein a first registered user is specified in the token payer field.

91. The system of claim 72 wherein a second registered user is specified in the token payee field.

92. The system of claim 73 wherein the token management subsystem transfers the user-defined value in response to the redemption request from the at least one receiving device from an interim holding account to a user account for a registered user on the at least one server when the token designation type is a token regular type.

93. The system of claim 73 wherein the token management subsystem transfers a user-specified value in response to the redemption request from the at least one receiving device from an interim holding account to a user account of a registered user on the at least one server when the token designation type is a token regular type, the user-specified value being less than the user-defined value, the registered user specifying the user-specified value.

94. The system of claim 73 wherein the token management subsystem, in response to the redemption request from the at least one information receiving device, is operative to:
transfer the user-defined value from an interim holding account to a user account for a registered user on the at least one server when the token designation type is a token raked type, the registered user being a token redeemer; and
transfer a transfer-fee from the interim holding account to a token-transaction-redemption account on the at least one server, the transfer-fee being less than the user-defined value.

95. The method of claim 73 wherein the token management subsystem, in response to the redemption request from the at least one information receiving device, is operative to:
transfer a user-specified value from an interim holding account to a user account of a registered user on the at least one server when the token designation type is a token raked type, the user-specified value being less than the user-defined value, the registered user specifying the user-specified value, the registered user being a token redeemer; and
transfer a transfer-fee from interim holding account to a token-transaction-redemption account on the at least one server, the transfer-fee being less than the user-defined value.

96. The system of claim 62 wherein the at least one information sending device includes at least one of a desktop computer, a laptop computer, a personal digital assistant, an Internet-enabled telephone and a mobile telephone.

97. The system of claim 62 wherein the at least one information receiving device includes at least one of a desktop computer, a laptop computer, a personal digital assistance, a mobile telephone, an Internet-enabled telephone, a vending machine, a laundry washing machine and a laundry drying machine.

98. The system of claim 66 wherein a secure communication connection is established on the first communication network between the secure application programming interface and the at least one information sending device.

99. The system of claim 98 wherein the secure communication connection is a Secure Sockets Layer connection.
